(19) United States
(12) Patent Application Publication
(10) Pub. No.: US 2014/0324460 A1
(43) Pub. Date: Oct. 30, 2014

(54) METHOD FOR DETERMINING AND MANAGING TOTAL CARDIODIABETES RISK

(71) Applicant: Health Diagnostic Laboratory, Inc., Richmond, VA (US)

(72) Inventors: Rebecca CAFFREY, N Chesterfield, VA (US); Steve VARVEL, Richmond, VA (US); James V. POTTALA, Richmond, VA (US); Szilard Voros, East Setauket, NY (US)

(73) Assignee: Health Diagnostic Laboratory, Inc., Richmond, VA (US)

(21) Appl. No.: 14/038,698

(22) Filed: Sep. 26, 2013

Related U.S. Application Data
(60) Provisional application No. 61/724,071, filed on Nov. 8, 2012.
(60) Provisional application No. 61/705,946, filed on Sep. 26, 2012.

(51) Int. Cl. G06F 19/00

(52) U.S. Cl. CPC G06F 19/3431
USPC 705/3

(57) ABSTRACT

A method for generating a report presenting a patient-specific information relevant to assessing a patient's cardiodiabetes risk to guide and allow a physician or healthcare provider in the choice of therapy or therapies that will be maximally effective for a specific patient, to monitor the response to the chosen therapy and reduce the patient's risk of developing cardiodiabetes and/or its complications.

### CROSS-REFERENCE TO RELATED APPLICATIONS

This application claims the benefit of priority to U.S. Provisional Patent Application Ser. No. 61/705,946, filed Sep. 26, 2012; and U.S. Provisional Patent Application Ser. No. 61/724,071, filed Nov. 8, 2012; both of which are hereby incorporated by reference in their entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD OF THE INVENTION

The patent application relates to personalized or patient-specific cardiodiabetes health reports and methods of generating such reports. In particular, this application describes how a patient-specific information relevant to a patient's cardiodiabetes risk are collected, selected, organized, and presented on the cardiodiabetes health reports to guide and allow a physician or healthcare provider in the choice of therapy or therapies that will be maximally effective for a specific patient, to monitor the response to the chosen therapy and reduce the patient's risk of developing cardiodiabetes and/or its complications.

### BACKGROUND OF THE INVENTION

Current diagnostic and prognostic testing to guide therapy decisions for cardiodiabetes is inadequate. Various tests for type 2 diabetes mellitus (T2DM), type 1 diabetes mellitus (T1DM), insulin resistance, dyslipidemia, glycemic control, and inflammation are available and some of these tests are offered in panels. However, each panel currently in commercial use falls short. The onset of cardiodiabetes, the course of the disease and health consequences for individual patients vary greatly. This may be due to multiple underlying physiological processes, e.g., genetics, environment, diet, exercise, medications, and co-morbidities that all play a role in the development of cardiodiabetes. Beta cell dysfunction, insulin resistance, glycemic control, inflammation, and dyslipidemia are all separate but inextricably inter-related physiological processes that work together in the initiation and progression or remission of cardiodiabetes. Therefore, standard diagnostic tests and panels that measure the contribution of one physiological process without integrating data from the others can lead to an incomplete clinical picture and this lack of access to more comprehensive information by healthcare providers may result in sub-optimal decision-making when selecting treatments for patients based on test results to reduce their risk of cardiodiabetes and improve their health.

All current commercially available diagnostic metabolic panels are incomplete, because they do not bring together classes of analytes for Glycemic Control, Beta Cell Function, Insulin Resistance (defined as pre-diabetic “metabolic syndrome” often with normal fasting glucose), in addition to panels of analytes measuring inflammatory processes and dyslipidemia. Inflammatory processes and dyslipidemia can drive the development and progression of insulin resistance and cardiodiabetes. To obtain a complete picture of the health and risk level of an individual, all 5 of these classes of parameters must be measured.

Thus, there is a need to improve upon the existing technology that employs traditional panels of biomarkers in each physiological areas and to enhance the quality of information obtained from each of these panels. There is also a need to improve the “big picture” to produce the most complete dataset on the cardiodiabetes status of a given patient which would aid in clinical decision-making and therapy guidance, resulting to a measurable cardiodiabetic risk reduction and better health outcome. This invention answers these needs.

### SUMMARY OF THE INVENTION

This invention relates to a method, through the use of a computer processor, of generating a report that contains a patient-specific information relevant to the assessment of a patient's cardiodiabetes risk. The method comprises (a) collecting, using the processor, the results of a biomarker test specific to a patient, wherein the biomarker test includes quantitative measurement of at least one biomarker from at least three (3) of the following panels: (1) a total glycemic control panel; (2) a beta cell function panel; (3) an insulin resistance panel; (4) an inflammation panel; and (5) a dyslipidemia panel, (b) selecting, using the processor, a cardiodiabetes categorical risk level based on the patient's results of the biomarker test, (c) organizing, using the processor, the results of the biomarker test and the cardiodiabetes categorical risk level in a patient-specific cardiodiabetes health report, and (d) presenting the patient-specific cardiodiabetes health report, wherein the report comprises the cardiodiabetes categorical risk level assessing the cardiodiabetic health significance of the results of each biomarker test for each biomarker panel, wherein the cardiodiabetes categorical risk level is assigned based on a comparison of the biomarker test results of the patient with a reference value range.

In an exemplary embodiment, the total glycemic control panel includes one or more biomarkers selected from glucose, HbA1c, fructosamine, glycation gap, D-mannose, and 1,5-anhydroglucitol (1,5-AG) and, optionally, α-hydroxybutyrate (AHB).

In another exemplary embodiment, the beta cell function panel includes one or more biomarkers selected from serum amylase, anti-glutamic acid decarboxylase (GAD) autoantibody, c-peptide, and intact pro-insulin and, optionally, one or more biomarkers selected from; glucagon-like peptide 1 (GLP-1); c-peptide/insulin ratio; intact pro-insulin/insulin ratio; [c-peptide+pro-insulin]/insulin ratio; an autoantibody against pancreatic islet cells; an autoantibody against amylase alpha-2 and α-hydroxybutyrate (AHB).

In yet another exemplary embodiment, the insulin resistance panel include one or more biomarkers selected from D-mannose, leptin, adiponectin, ferritin, and free fatty acids (FFA), and, optionally, one or more biomarkers selected from α-hydroxybutyrate (AHB); oleic acid; linoleoyl-glycerophosphocholine (L-GPC); lipoprotein insulin resistance (LP-IR) score; glucagon-like peptide 1 (GLP-1); mannose binding lectin (MBL) level, activity, genetic polymorphisms or known haplotypes thereof; and body mass index (BMI).

The inflammation panel, according to another embodiment of the invention, includes one or more biomarkers selected from lipoprotein-associated phospholipase A2 (LpPLA2), fibrinogen, high sensitivity C-reactive protein (hsCRP), myeloperoxidase (MPO) and F2-isoprostanes and, optionally, one or more biomarkers selected from the group consisting of serum amyloid A and variants thereof; HSP-70; IL-6; TNF-α; haptoglobin and variants thereof; secretory phospholipase A2 (sPLA2); pregnancy-associated plasma protein-A (PAPP-A); and mannose binding lectin (MBL) level, activity, genetic polymorphisms or known haplotypes thereof.

The dyslipidemia panel, on the other hand, includes one or more biomarkers selected from LDL-C; HDL-C; triglycerides; apolipoprotein B-48 (ApoB-48); remnant-like lipoprotein particles (RLPs) or RLP-associated cholesterol (RLP-c); linoleoyl-glycerophosphocholine (L-GPC); and at least one additional lipid particle measurement selected from the group consisting of LDL-P, HDL-P (total), large VLDL-P, small LDL-P, large HDL-P, VLDL size, LDL size, HDL size and LP-IR score and, optionally, one or more biomarkers selected from the group consisting of the lipid particle measurements of enumerated in FIGS. 2 and 3; the measurement of cholesterol and/or triglycerides contained within one or more specific subtypes of lipoprotein particles and remnants thereof; and mannose binding lectin (MBL) level, activity, genetic polymorphisms or known haplotypes thereof.

The total glycemic control panel may comprise (1) two or more biomarkers or (2) three or more biomarkers selected from glucose, HbA1c, fructosamine, glycation gap, D-mannose, 1,5-anhydroglucitol (1,5-AG).

The beta cell function panel may comprise (1) two or more biomarkers or (2) three or more biomarkers selected from serum amylase, anti-glutamic acid decarboxylase (GAD) autoantibody, c-peptide, and intact pro-insulin.

The insulin resistance panel may comprise (1) two or more biomarkers or (2) three or more biomarkers selected from D-mannose, leptin, adiponectin, ferritin, and free fatty acids (FFA).

The inflammation panel may comprise (1) two or more biomarkers or (2) three or more biomarkers selected from the group consisting of lipoprotein-associated phospholipase A2 (LpPLA2), fibrinogen, high sensitivity C-reactive protein (hsCRP), myeloperoxidase (MPO) and F2-isoprostanes.

The dyslipidemia panel may comprise (1) two or more biomarkers or (2) three or more biomarkers selected from the group consisting LDL-C; HDL-C; triglycerides; apolipoprotein B-48 (ApoB-48); remnant-like lipoprotein particles (RLPs) or RLP-associated cholesterol (RLP-c); linoleoyl-glycerophosphocholine (L-GPC); and at least one additional lipid particle measurement selected from the group consisting of LDL-P, HDL-P (total), large VLDL-P, small LDL-P, large HDL-P, VLDL size, LDL size, HDL size and LP-IR score.

In one of the embodiments of the invention, the cardiodiabetes categorical risk level can be selected by comparing the biomarker test results of the patient with the standard reference levels of the biomarkers and can be categorized as optimal (low risk), intermediate (elevated risk) or high risk.

In one embodiment, the method further includes evaluating the cardiodiabetes categorical risk level against one or more clinical endpoint components of the cardiodiabetic disease. These one or more clinical endpoint components of cardiodiabetic disease encompasses, e.g., measurements of blood glucose level at any time point in an OGTT or mixed meal challenge, measurements of blood insulin level at any time during an OGTT or mixed meal challenge, early signs of impaired first and/or second phase insulin secretion, early signs of impaired incretin response, early signs of impaired glucose disposal rate, early signs of adipose insulin resistance, early signs of hepatic insulin resistance, early signs of microvascular cardiodiabetic disease, and early signs of macrovascular cardiovascular disease. The evaluated cardiodiabetes categorical risk level is then entered to the patient-specific cardiodiabetes health report.

The patient-specific cardiodiabetes health report provides information relative to a patient's risk of a cardiodiabetes disorder and complications thereof, wherein the cardiodiabetes disorder and complications thereof may include insulin resistance, metabolic syndrome, type 2 diabetes mellitus (T2DM), type 1 diabetes mellitus (T1DM), fatty liver, diabetic nephropathy, diabetic neuropathy, vasculitis, atherosclerosis, coronary artery disease (CAD), vulnerable plaque formation, myocardial infarction (MI), cardiomyopathy, endothelial dysfunction, hypertension, occlusive stroke, ischemic stroke, transient ischemic event (TIA), deep vein thrombosis (DVT), dyslipidemia, gestational diabetes (GDM), periodontal disease, obesity, morbid obesity, chronic and acute infections, pre-term labor, diabetic retinopathy, and systemic or organ-specific inflammation.

Another embodiment of the invention further includes selecting a recommendation for a therapy regimen for the patient based on the patient-specific cardiodiabetes health report. The therapy regimen may encompass administration of a drug or supplement; additional diagnostic testing; treatment for chronic infection; referral to a health specialist or a related specialist; making or maintaining lifestyle choices based on said patient-specific cardiodiabetes health report, or combinations thereof.

For administration, the drug may be an anti-inflammatory agent, an antithrombotic agent, an anti-platelet agent, a fibrinolytic agent, a lipid reducing agent, a direct thrombin inhibitor, a glycoprotein IIb/IIIa receptor inhibitor, an agent that binds to cellular adhesion molecules and inhibits the ability of white blood cells to attach to such molecules, a PCSK9 inhibitor, an MTP inhibitor, mipmercin, a calcium channel blocker, a beta-adrenergic receptor blocker, an angiotensin system inhibitor, a glitazone, a GLP-1 analog, thiazolidinedionones, biguanides, neglitinides, alpha glucosidase inhibitors, insulin, a dipeptidyl peptidase IV inhibitor, metformin, sulfonurea or peptidyl diabetic drugs.

Examples of lifestyle choices may include changes in diet and nutrition, changes in exercise, smoking reduction or elimination, or a combination thereof.

The biological sample, according to the embodiments of the invention, may be blood component, saliva or urine.

The computer processor can be operably coupled to a computer database and may include executed software programs for data interpretation.

To transmit the results of the biomarker test to a physician, health provider or patient, the cardiodiabetes health report may be printed, faxed, or in an electronic format viewable on a personal computer or handheld device.

In another embodiment of the invention, the quantitative measurements of the biomarkers can be transformed collectively by a mathematical operation using the processor to generating a cardiodiabetes index score. The cardiodiabetes categorical risk level is assigned in conjunction with the generated cardiodiabetes index score by the processor. The generated cardiodiabetes index score is compared with a reference value range and is assigned to a cardiodiabetes categorical risk level that includes optimal (low risk), intermediate (elevated risk) or high risk.

In addition, the generated cardiodiabetes index score is further evaluated against one or more clinical endpoint components of cardiodiabetic disease as described hereinabove.

Further, the patient-specific cardiodiabetes health report may include the generated cardiodiabetes index score and the cardiodiabetes categorical risk level is assigned in conjunction with the generated cardiodiabetes index score by the processor.

Additional aspects, advantages and features of the invention are set forth in this specification, and in part will become apparent to those skilled in the art on examination of the following, or may learned by practice of the invention. The inventions disclosed in this application are not limited to any particular set of or combination of aspects, advantages and features. It is contemplated that various combinations of the stated aspects, advantages and features make up the inventions disclosed in this application.

### BRIEF DESCRIPTION OF THE DRAWINGS

FIG. 1 shows an exemplary of a metabolic panel.

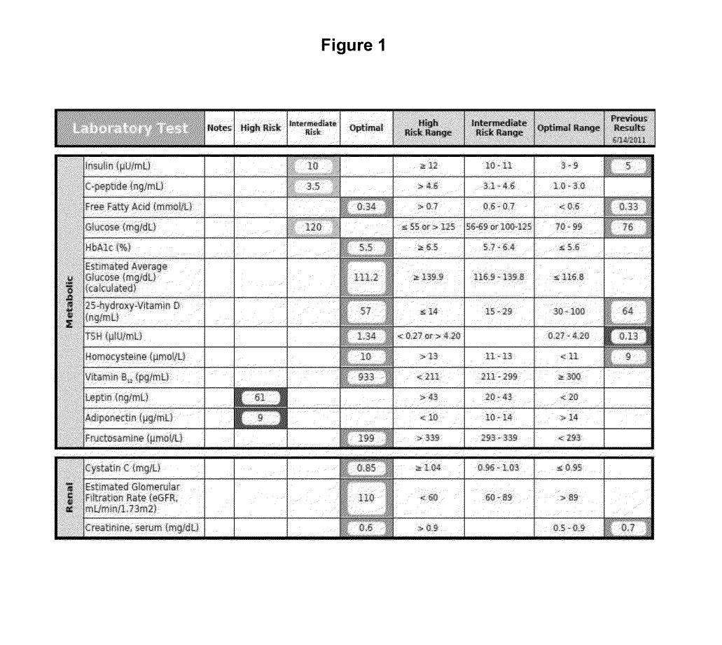

FIG. 2 shows an exemplary lipid and lipoprotein test panel.

FIG. 3 shows an exemplary lipoprotein test panel for particle size and particle number measurements.

FIG. 4 shows the OGTT curve for FFA times C-peptide in a 2-hour glucose response (plus Glycomark, MBL Mass).

FIG. 5 shows the OGTT curve for FFA times C-peptide in a 1-hour glucose response (minus Glycomark, MBL Mass).

FIG. 6 shows the OGTT curve for FFA times C-peptide in a 1-hour glucose response (plus Glycomark, MBL Mass).

FIG. 7 shows a Heat map display of absolute value of Pearson's correlation between individual biomarkers and cluster component scores corresponding to Table 2 (7 clusters).

FIG. 8 shows Heat map of absolute value of Pearson's correlation between individual biomarkers and cluster component scores corresponding to Table 7 (13 clusters).

### DETAILED DESCRIPTION OF THE INVENTION

Cardiovascular disease (CVD) is the major cause of death in patients with type 2 diabetes mellitus (T2DM). The objective of the invention is to bring together panels of the most predictive and informative diagnostic analytes in 5 different metabolic processes that underpin the development of T2DM and cardiovascular disease in order to facilitate diagnosis, optimize therapy, and lower the patients' cardiovascular risk and risk of developing full T2DM, thus improving outcome. The analytes in the Method described herein for of cardiodiabetes risk management relate to five unique and inter-related panels of tests with diagnostic and prognostic value for: 1) Total Glycemic Control, 2) Beta Cell Function, 3) Insulin Resistance, 4) Inflammation, and 5) Dyslipidemia. These five subpanels in each of the distinct but physiologically related areas give different information that allows clinicians to choose therapies that will be maximally effective for a given patient, monitor the response to the chosen therapy(ies), and reduce the patient's risk of development of cardiovascular diseases and other serious complications of insulin resistance, inflammation, diabetes, and dyslipidemia. The simultaneous use of multiple biomarkers with independent classification power will increase the performance of the biomarker panel in characterizing cardiodiabetes.

TABLE 1
Core Claimed Analytes and Scores, and Optional/Accessory Claimed
Analytes and Scores Comprising the 5 Test Panels (note that
some analytes may inform more than one category)

| | Core | Optional/ |
|---|---|---|
| Panel | Biomarkers | Accessory |
| Total | glucose, HbA1c, | AHB |
| Glycemic | fructosamine, | |
| Control | glycation gap, | |
| | D-mannose, 1,5 A-G | |
| Beta | serum amylase, anti- | GLP-1, fasting insulin, ratio |
| Cell | GAD auto-antibody, | c-peptide/insulin, ratio intact |
| Function | c-peptide, intact | pro-insulin/insulin, ratio |
| | pro-insulin, AHB | [c-peptide + pro-insulin]/ |
| | | insulin, other autoantibodies |
| | | against pancreatic islet |
| | | cells such as amylase |
| | | alpha2 autoantibody, AHB |
| Insulin | D-mannose, leptin, | Fasting insulin, oleic Acid, |
| Resistance | adiponectin, ferritin, | L-GPC, GLP-1, alpha |
| | and Free Fatty Acids | hydroxybutyrate, MBL |
| | (FFA) | amount, activity, or |
| | | genetic polymorphisms |
| | | thereof, BMI, LP-IR Score |
| Inflammation | LpPLA2, | HSP 70, IL-6, TNF-α, |
| | fibrinogen, hsCRP, | SAA variants, haptoglobin |
| | Myeloperoxidase (MPO), | variants; secretory |
| | F2-isoprostanes | phospholipase A2 (sPLA2); |
| | | pregnancy-associated plasma |
| | | peptide A (PAPP-A), MBL |
| | | amount, activity, or genetic |
| | | polymorphisms thereof. |
| Lipids and | FFA, triglycerides, | Lipid particle measurements |
| Lipoproteins | RLP, ApoB-48, L-GPC, | enumerated in tables 2 and 3; |
| | LP-IR score, | the measurement of choles- |
| | LDL-c, HDL-c | terol and/or triglycerides |
| | | contained within one or more |
| | | specific subtypes of lipo- |
| | | protein particles and remnants |
| | | thereof, and Mannose Binding |
| | | Lectin, MBL) and associated |
| | | genetic polymorphisms and |
| | | known haplotypes thereof |

For the analytes specifically discussed below as well as other analytes mentioned in Table 4, accessory biomarkers, it will be understood that the value of the measured analyte used in the assessment of cardiodiabetes risk may be the actual measured value, or in some cases a mathematically transformation of the value, embodied by the non-limiting examples of natural logarithms (Ln), ratios of a biomarker to one or more other biomarkers, or quotients. Furthermore, all protein biomarkers claimed refer to any and all of the variants comprising the “wild type” protein, variants due to SNPs, variants due to differential associations of multiple primary chains into secondary, tertiary, quaternary structures, post-translational modifications, glycosylations, fragments, dimers, trimers, tetramers, and n-mers, etc.

### Total Glycemic Control

### Glucose

Glucose, when measured in blood should be within a normal range, and if elevated, becomes an indicator of insulin resistance (also known as metabolic syndrome) and forms of diabetes mellitus. Measurement of glucose can usually be done in the fasting state and values below 100 are considered normal. Measurement of glucose can be done once, or serial measurements of glucose and insulin can be taken together in the form of an oral glucose tolerance test (OGTT). In a normal patient, baseline glucose and insulin increase when the patient ingests a bolus of glucose, and repeated measurements show glucose and insulin rise then return to the normal baseline values within an hour or 2 hours after ingestion of the sugar. In insulin resistant patients, blood glucose and/or insulin levels remain elevated for a longer period of time. Measurement of glucose at any given time does not give an indication of long or short-term control of blood glucose and presence of disease and this measurement must be combined with other measured analytes such as those listed hereinbelow to make a definitive diagnosis of insulin resistance and diabetes.

### Beta Cell Dysfunction

### Insulin

Insulin and intact pro-insulin are currently measured to determine the level of pancreatic beta cell function and can be used as markers for insulin resistance, type 2 diabetes, and type 1 diabetes. Very low levels of forms of insulin may indicate that the pancreatic beta cells are not secreting insulin and type 1 diabetes is present. Fasting insulin above the normal baseline value may also indicate that an individual is insulin-resistant or is developing type-2 diabetes mellitus. Insulin is more commonly measured than pro-insulin although both correlate with cardiodiabetes and cardiovascular risk from insulin resistance and diabetes. Both are commonly measured and can be used to track disease progression and therapy effectiveness. Intact insulin is therefore an informative biomarker regarding cardiodiabetic risk when added as an accessory biomarker to the panel of claimed core biomarkers for both the Beta Cell Function panel and the Insulin Resistance Panel.

### Intact Pro-Insulin

Intact Pro-Insulin is not normally detected in the blood of individuals without T2DM and insulin resistance, as it is a product of beta cell dysfunction. When insulin is not sufficiently processed before secretion by the pancreatic beta cells, immature forms of insulin make up the majority of circulating insulin immune-reactive pool in both fasting and glucose-stimulated conditions (insulin immunoreactivity, as described herein, refer to all molecules detectable by an insulin antibody, i.e. insulin, proinsulin, and proinsulin-like material). Hyperproinsulinemia is more frequent in type 2 diabetes and has been attributed to either a direct β-cells defect or an indirect effect of cell dysregulation under sustained elevated blood glucose (hyperglycemia).

### C-Peptide

C-peptide levels may be elevated as a result of increased β-cell activity observed in hyperinsulinism of insulin resistance or T2DM, from renal insufficiency, and from obesity. C-peptide may be measured in women with PCOS as an approximation of level of insulin resistance; also, C-pep can be used as a proxy measurement for insulin secretion in Type 1 diabetics who are insulin-dependent. Correlation has been found between higher C-peptide levels and increasing hyperlipoproteinemia and hypertension.

### Hemoglobin A1c

HbA1c or hemoglobin A1c is a glycosylated form of hemoglobin that is elevated in the serum of patients with persistently high blood glucose, such as patients with insulin resistance and type 2 diabetes. HbA1c equilibrates in the serum over 6-12 weeks and, therefore, measurement of this analyte gives only an estimate of the patient's long-term control over blood-glucose levels. HbA1c is commonly measured to track progression of insulin resistance/diabetes and to assess therapy effectiveness.

### 1,5-Anhydroglucitol (1,5 AG)

1,5-anhydroglucitol (1,5 AG), an analyte that increases in urine but decreases in blood when blood glucose undergoes excessively high elevations for longer than normal periods of time after patients eat meals. These short term elevations are referred herein as “post-prandial excursions.” 1,5 AG is a non-metabolized monosaccharide present in small amounts in most foods. 1,5 AG reflects peak glucose levels over 1-2 weeks (short term glucose control). These peaks, not detected by standard HbA1C testing, are associated with the cardiovascular complications of diabetes. 1,5 AG levels may assist in monitoring drug efficacy and treatment alterations including diet and exercise regimens in patients with their HbA1C at or near goal. 1,5 A-G levels decrease in urine when blood glucose levels rise because glucose competes for the glucose transporters, GLUT2 and GLUT5, in the kidneys. As glucose concentrations rise in the blood and push 1,5 AG out of the tissue reserve spaces above the renal threshold of approximately 180, glucose and 1,5 AG are pushed into the urine through via GLUT2 and GLUT5 transporters and, therefore, less 1,5 AG is retained in the blood, resulting in higher urine 1,5 AG levels. Because glucose and 1,5 AG compete more strongly for the GLUT2 and GLUT5 transporters in kidney than D-mannose (discussed below), D-mannose will be elevated in plasma before 1,5 AG (before glucose excursions reach the renal threshold).

1,5 AG can be a useful biomarker for large post-prandial glucose excursions and a clinically relevant biomarker. The inclusion of 1,5 AG to the Total Glycemic Control Panel, as described herein a novel advantage over traditional glycemic control panels. The inclusion of D-mannose to the traditional test panels may further provide earlier information regarding dysregulation of glycemic control than 1,5 AG due to differences in renal uptake of the 2 sugars. This is primarily because 1,5 AG blood levels do not change with a single OTT, and may not change measurably during or after an OGTT, or until several glucose loads have been administered. 1,5 AG assay for postprandial hyperglycemia is marketed commercially by GlycoMark and developed by Nippon Kayaku, Inc.

### Fructosamine

Fructosamine measures amino acids conjugated to sugars and is measurably elevated in hyperglycemic patients. This analyte provides a good approximation of glucose control over the past 10-14 days. It may not be specific to post-prandial glucose excursions, but can be a good indicator of the level of glycemic control in a longer time frame than 1,5 AG and AHB, and a shorter time frame than HbA1c.

### Glycation Gap

Glycation Gap (also known as glycosylation gap) is the discordance between HbA1c and fructosamine. Several shorter-term markers of glycemic control, such as, glycated serum proteins or fructosamine, and glycated albumin reflect average glucose levels over a matter of days to weeks and are more sensitive to large glucose fluctuations but these glycated proteins are not specifically clinically measured in assessing cardiodiabetes risk for a variety of reasons but these glycated proteins are not specifically clinically measured in assessing cardiodiabetes risk for a variety of reasons. The difference between the actual measured HbA1c concentration and the predicted HbA1c from glycated serum protein is called the glycation gap. The glycation gap value predicts diabetic co-morbidities more reliably than HbA1c alone.

### D-Mannose

D-Mannose is a sugar that is present at elevated levels in the fasted state of early insulin resistant and diabetic patients. D-mannose is a hexose-like glucose, but its uptake and metabolism is completely different. Mannose levels in plasma are much less variable than glucose levels, and mannose levels correlate much more closely to the CVs of daily glucose than glucose itself. Because mannose transporters are insulin independent, unlike the GLUT4 glucose transporter, mannose levels increase less than glucose levels in response to a meal and don't follow the same kinetic patterns in an OGTT test (Sone et. al., 2003). D-mannose measurements in fasting plasma (Fasting Plasma Mannose; FPM) have been reported to be even more sensitive in detecting early-stage insulin resistance than fasting plasma glucose (FPG) or OGTT testing (see EP 1376133A1). This study found that the standard level of FPM was 6.6+/−2.4 μg/ml, with an upper limit of normal of 9 μg/ml. Measurements of FPM greater than 9 μg/ml identified the patients in very early stages of insulin resistance who still had normal FBG and OGTT. A large study on the metabolomics of early insulin resistance and glucose intolerance in a non-diabetic patient subset of the RISC cohort, found that D-mannose was one of the top-ranked metabolites that correlated with the bottom third (worst) of patients as assessed by hyperinsulinemic-euglycemic clamp (Gall et. al., 2010). A third study of interest demonstrated another link between plasma mannose and insulin resistance, wherein it was found that increased mannose/glucose ratio is higher in insulin resistant and diabetic patients, and this increased ratio correlates with dyslipidemia (see Pitkanen, 1999).

Mannose is one of the sugars that can be transported passively into the pancreas, along with glucose, as the pancreas passively monitors blood glucose for rises that indicate the need to secrete greater amounts of insulin after meals. In the kidney, GLUT 2 and GLUT5 transporters are the transporters that normally excrete 1,5 anhydroglucitol (1,5 A-G) and take up excess glucose for urinary excretion during episodes of hyperglycemia. These transporters also take up mannose and fructose, but when mannose and fructose are removed from the circulation by the kidneys (under normal physiological conditions), they are not excreted into the urine like 1,5 A-G and glucose (Yamanouchi, et. al., 1996). Because 1,5 A-G and glucose compete with mannose and fructose for GLUT2 and GLUT5 transporters on the renal tubules, the presence of 1,5 A-G and glucose significantly inhibits reabsorption of mannose. Even small elevations in plasma glucose and 1,5 A-G being displaced from the tissue space pool by increased glucose will competitively inhibit mannose removal from plasma, and result in higher baseline mannose plasma levels (FPM), as well as higher levels of mannose after an OGTT. Retention of mannose in the bloodstream at higher levels in the context of mild hyperglycemia in the early stages of insulin resistance would be the basis to include mannose in the glycemic control panel, as the only other analyte that is non-metabolized and whose measurement depends entirely on kidney elimination is 1,5 AG, and this analyte moves in the opposite direction (decreases) in plasma whereas D-mannose increases. Additionally, plasma mannose levels vary measurably during OGTT and HI, whereas 1,5 AG may not decrease till hours later, or until after administration of several hyperglycemic loads. Therefore, while the analytes are related in terms of ability to show dysregulated glycemic control, their time course, trajectory and metabolic fates distinguish them from one another such that they each give unique information as part of a panel.

Additionally, D-mannose has been shown to be a biomarker of early hepatic insulin resistance. It has been shown that the majority of D-mannose is derived from the breakdown of liver glycogen (glycogenolysis) (see Taguchi et. al., 2005). This study hypothesized that the elevated plasma mannose concentration encountered in diabetes maybe associated with insulin resistance in liver and/or overactivity of glucagon on the liver. This would be in agreement with current dogma concerning the overproduction of glucose from glycogenolysis and gluconeogenesis in the livers of insulin resistant and diabetic humans and animal models (see Cersosimo et al., 2011). Another study supporting the association of elevated plasma D-mannose with hepatic insulin resistance, specifically, showed that mannose was significantly elevated in a cohort of non-diabetic subjects with fatty liver (non-alcoholic fatty liver disease (NAFLD) and nonalcoholic steatohepatitis (NASH)) (see Kalhan, et. al., 2010). Fatty liver is an often silent, asymptomatic early development in the continuum of insulin resistance and diabetes; it is associated with dyslipidemia and increases risk of atherosclerosis, and often occurs in conjunction with elevated free fatty acids. Hepatic insulin resistance can result in fatty liver, and may drive the development of peripheral (vascular) insulin resistance and cardiodiabetes. Therefore, the inclusion of mannose in the panel for insulin resistance is a novel approach because mannose, unlike the other biomarkers, can be linked mechanistically to the development of hepatic insulin resistance rather than pancreatic or other organs.

In an experiment where non-diabetic (i.e. insulin sensitive) humans after oral dosing with mannose or fructose prior to glucose infusion resulted in an augmented insulin response and glucose load to the subsequent intravenous glucose infusion, when compared to intravenous glucose alone. Enhanced glucose disposal rate of the iv glucose load occurred after both oral mannose and oral fructose administration. The researchers concluded that mannose, despite weak transport across gut or kidney, evokes significant “betacytotropic” effects. See Ganda et al., 1979. Because D-mannose is so closely related to fructose and can be interconverted via an enzyme (mannose isomerase), it is possible that the “oral loading” on fructose that occurs in the Westernized diet may result in some degree of elevated plasma D-mannose; the association between high fructose diets and development of insulin resistance, fatty liver, and diabetes is well established, and therefore D-mannose is a logical, if underutilized and underappreciated, biomarker for dysregulation of glycemic control, beta cell dysfunction, and insulin resistance, and confers novelty to the Total Glycemic Control Panel.

### Serum Amylase

Serum Amylase is an enzyme produced by the pancreas, and is an analyte that most people associate with pancreatitis and pancreatic cancer. However, low serum amylase is more commonly associated with the pancreatic dysfunction and insulin deficiency in patients with type 1 diabetes and with type 2 diabetes, and with the pathogenesis of insulin resistance in obese animal models. In humans, low serum amylase has also been associated with increased risk of metabolic abnormalities, metabolic syndrome (MetS), and diabetes, which may be due to the pancreatic exocrine/endocrine relationship; also, serum amylase levels are inversely correlated with most cardiometabolic risk factors, including obesity (Nakajima et al., 2011a). Accordingly, serum amylase generally correlates inversely with BMI (Nakajima et al., 2011b). But low serum amylase has been shown to correlate with decreased baseline plasma insulin levels and insulin secretion, as well as asymptomatic insulin resistance, even after adjustment for BMI (Muneyuki et. al., 2012). Also, the lowest quartile of serum amylase measurements in one study was significantly associated with the increased risk for metabolic syndrome and diabetes even after adjustment for clinical confounders such as estimated glomerular filtration rate (eGFR; Nakajima et al., 2011(a)); however, the decline in serum amylase was independent of smoking status, which is itself a strong predictor of the development of insulin resistance and cardiovascular disease. Accordingly, serum amylase may reflect abnormal glucose metabolism, and impaired insulin action due to either insulin resistance or inadequate insulin secretion.

The addition of serum amylase to the beta cell function panel confers not only a biomarker of beta cell dysfunction that is independent of kidney dysfunction as measured by eGFR, but the association of lowered serum amylase may provide insight into whether the etiology of a patient's metabolic abnormality is due to T1DM or T2DM (insulin resistance). Lowered serum amylase when observed in conjunction with hyperinsulinemia, high levels of c-peptide, or high levels of intact pro-insulin, would indicate the onset of the beta cell dysfunction occurring on the continuum of insulin resistance/T2DM. Low levels of serum amylase in conjunction with low levels of endogenous insulin (hypoinsulinemia) or c-peptide would indicate T1DM, i.e., destruction of the pancreatic beta cells. This triple utility also makes serum amylase useful for the monitoring of therapy of type 1 diabetics, whose diabetes is of autoimmune origin and is known to go into periods of remission in many individuals just as other autoimmune diseases do. Furthermore, Type 2 diabetics may develop Type 1 diabetes due to aforementioned autoimmune processes while many adult-onset patients who are presumed to be Type 2 are in fact misdiagnosed type 1 diabetics. For these reasons, serum amylase may add unique diagnostic and prognostic utility to the beta cell dysfunction panel and critical information for therapy guidance.

### Anti-GAD Autoantibody

Anti-GAD autoantibody is the predominant autoantibody to pancreatic islet cells detectable in the plasma of patients who are developing T1DM. T1DM is often thought of as only occurring during childhood; adult-onset diabetes is usually presumed to be T2DM. However, adults may also develop T1DM. It is estimated that between 10-20% of adults who are being treated as Type 2 diabetics have T1DM. T1DM must be identified and distinguished from T2DM for it to be monitored and treated effectively. Most Type 1 diabetics require exogenous administration of insulin to resolve their elevated blood sugar levels and to survive; it is possible with very early detection of T1DM before total destruction of the pancreatic islet cells to intervene with immunosuppressive therapy and preserve function of the islet cells, put the patient into remission, and either reduce or eliminate temporarily the need for exogenous insulin. Standard beta cell dysfunction/glycemic control panels may not identify Type 1 diabetics and distinguish them from T2DM, as most of these diagnostic panels focus on exclusive identification of the insulin resistant and T2DM patients. Testing for anti-GAD antibody, serum amylase, and the other analytes in the core panel, in addition to some analytes listed in the supplementary panel, provides a novel beta cell dysfunction measurement tool to allow clinicians to diagnose, prognose, monitor, and guide therapy decisions in the context of either T1DM or the T2DM continuum.

AHB has been experimentally evaluated to be of significance in placing patients on a continuum of glucose tolerance from NGT to full-blown T2DM, and has been correlated with impaired whole-body glucose disposal rate and insulin resistance. It has also been positively correlated with metabolic syndrome and BMI. However, AHB levels in human blood are specifically correlated to an impaired first-phase insulin secretory response, which suggests sub-clinical beta cell dysfunction particularly when measured in individuals with apparently normal glucose tolerance by all other measures. In fact as the level of AHB in a baseline fasting sample of human blood rises, there is an increasing likelihood that an individual will have clinically significant post-prandial glucose excursions at 30 minutes and 60 minutes in an OGTT. In normoglycemic individuals (apparent NGTs) the level of AHB at baseline therefore shows subclinical beta cell dysfunction and is therefore a useful proxy biomarker, at baseline without doing an OGTT, for which patients are much more likely to be IGT, and therefore at increased risk of cardiodiabetes development and complications, particularly microvascular complications. See U.S. Provisional Patent Applications 61/751,328, 61/831,337 and 61/831,405, filed Jan. 11, 2013, Jun. 5, 2013, and Jun. 5, 2013, respectively, entitled “Method of Detection of Early Insulin Resistance and Pancreatic Beta Cell Dysfunction in Normoglycemic Patients” and U.S. Provisional Patent Application 61/847,922, filed Jul. 18, 2013, entitled “Method of Determining of Risk of 2 Hour Blood Glucose Equal To or Greater Than 140 mL/dL,” all herein incorporated by reference in their entirety.

### Glucagon-Like Peptide-1 (GLP-1)

Glucagon-like peptide-1 is an incretin derived from the intestinal L cell that secretes it as a gut hormone. GLP-1 has a half-life of less than 2 minutes in the circulation due to rapid degradation by the enzyme dipeptidyl peptidase-4. GLP-1 is a potent antihyperglycemic hormone that induces glucose-dependent stimulation of insulin secretion but suppresses glucagon secretion. When the plasma glucose concentration is in the normal fasting range, GLP-1 does not continue to stimulate insulin release to cause hypoglycemia. GLP-1 may restore glucose sensitivity of pancreatic β-cells, and inhibits pancreatic β-cell apoptosis, as well as stimulating the proliferation and differentiation of insulin-secreting β-cells. When not enough of the active form of GLP-1 is present due to incretin defect or too much amount or activity of DPP-4, an impaired first-phase insulin secretion response may be seen on an OGTT, and hyperglycemia results. GLP-1 is similar to AHB in this effect, in that elevated levels of AHB appear to inhibit secretion of insulin by pancreatic beta cells, and low levels of GLP-1 fail to stimulate a first phase insulin secretion response (and protect beta cells from damage), thus delivering a 1-2 punch on beta-cell related aspects of glycemic control.

### Insulin Resistance

### Mannose Binding Lectin (MBL)

Mannose Binding Lectin (MBL) is the plasma acute phase protein that binds mannose and proteins that have been glycated with mannose, and especially those on bacterial cell walls. MBL activates the complement cascade through the lectin pathway and is important in the innate immune response. MBL deficiency is one of the most frequent immunodeficiencies, affecting approximately 10% of the general population. MBL deficiency is associated with inflammation, infections, development of gestational diabetes (GDM), development of autoimmunity, and is associated with the appearance of early insulin resistance, early atherosclerosis and more progressive forms of atherosclerosis (see Megia, et. al., 2004). MBL has been implicated in dyslipidemias and atherosclerosis because it assists in cholesterol efflux from macrophages, which is important in clearing atherosclerotic deposits from vascular walls; therefore insufficient MBL amount or activity can lead to accelerated atherosclerotic processes, especially in the context of cardiodiabetes.

In the complement cascade, MBL can bind lipoproteins and enhance the monocyte/macrophage clearance of LDL. MBL is also known to enhance HDL-mediated cholesterol efflux from macrophages (see Fraser and Tenner, 2010).

MBL deficiency has been correlated with the severity of atherosclerotic disease (Madsen et. al., 1998), and human population studies showed that high levels of MBL were associated with greatly decreased risk of myocardial infarction (MI) in hypercholesterolemic individuals (Saevarsdottir et al, 2005) The HUNT2 study on Norwegian population just published in April found that MBL deficiency doubled risk of MI (Vengen, et al., 2012).

Specific MBL genotypes are known to confer susceptibility to or resistance to atherosclerosis as well as infections, such as C. pneumonia, a gram-negative organism that is known to also initiate atherosclerosis. In fact, humans with MBL deficiencies tend to have recurring C. pneumonia infections, and other infections, due in part to MBL's role in normal innate immunity (complement cascade initiation). One study found that patients with severe atherosclerosis had a reduced frequency of the MBL A allele and an increased frequency of the MBL B, C, and D alleles compared with apparently healthy controls (Madsen et. al., 1998). Other studies have found that populations like Inuit Canadians who have remarkably low levels of atherosclerosis and also resistance to C. pneumonia infections have much higher allele frequency of the functional wild-type MBL-A alleles (Hegele et. al., 1999). Polymorphisms in the MBL gene promoter (termed H, L, X, and Y) may also contribute to the MBL deficiency syndrome (Madsen et al., 1995 and Salimans, et. al, 2004). It is the interplay of these alleles in the MBL gene itself and the promoter region that determines the amount of the protein expressed in the blood and the functionality (activity) of the MBL.

Only seven haplotypes (out of a possible 64) are commonly found combining to form 28 genotypes (Garred et al. 2009). In disease association studies, these genotypes are usually grouped into assumed low (YO/YO and YO/XA), medium (YA/YO and XA/XA) and high (YA/YA and YA/XA) conferring categories (Wallis and Lynch 2007). Most, but not all, individuals with A/A genotypes have serum MBL >600 ng/mL and those with O/O genotypes generally have serum MBL below 200 ng/mL (Swierzko et al. 2009). The A/O groups, however, are highly heterogeneous with respect to serum MBL values, despite average values being reported at ˜400 ng/mL and perhaps a majority having concentrations <600 ng/mL. (Chalmers et al., 2011)

MBL deficiency is not a condition that is often screened for. One reason that the therapy is not used often is that people are not screened; even if they were to be screened genetically, some studies show that heterozygotes with defective genes are symptomatic, and others show that homozygotes only are symptomatic and affected. Further confounding the picture is that people with genotypes who “should” have MBL deficiency have normal levels of the protein in their plasma and do not have symptoms of the disease. To date, there is no company that has adopted a complete screening approach wherein patients are screened for genotype in MBL gene, its promoter region, absolute amount of MBL present in serum, and the biological activity level of the MBL protein (Kuipers et. al., 2002). In an effort to determine which patients have clinically relevant MBL deficiency to get them the most appropriate therapy before a coronary artery disease (CAD) develops. Treatment for MBL deficiency, e.g., intravenous enzyme replacement therapies, exists. Enzon Pharmaceutical has developed rhMBL and it has been used clinically for treatment of a number of different conditions related to MBL deficiency (Peterson 2006).

### Adiponectin

Adiponectin is an adipocyte-specific protein that inhibits smooth muscle cell proliferation and adhesion of monocytes to endothelial cells and can thereby inhibit arteriosclerosis. In addition, it promotes lipid metabolism, enhances insulin sensitivity, and plays a key role in the pathogenesis of the metabolic syndrome. There is an inverse relationship with glucose tolerance and BMI, and low adiponectin is associated with diabetes and obesity-related cardiovascular disease. Weight loss and a healthy diet have been shown to favorably increase adiponectin levels, and some studies have also shown that exercise is beneficial.

### Leptin

Leptin is an adipocyte-derived protein hormone that modulates the central nervous system to alter appetite and energy utilization, as well as regulating many other physiological functions. These affects occur by its action on neuroreceptors in the brain. Leptin circulates at concentrations proportional to the amount of body fat. It increases with insulin resistance, and has an association with obesity-related cardiovascular disease. Elevations of leptin appear to cause hunger signals, which result in overeating. Consumption of fish (and fish oils), as well as caloric restriction, have been shown to favorably reduce leptin. Insulin resistance leads to leptin resistance and a reversal of the former can have a positive impact on leptin levels.

### Alpha Hydroxybutyrate (AHB)

AHB is a metabolite that has been correlated in the literature to impaired glucose disposal, the metabolic syndrome, and peripheral insulin resistance as measured by the clamp technique. It is used clinically together with L-GPC and OA to classify patients according to their glucose tolerance, i.e. NGT, IGT, etc. Levels of AHB increase with development of insulin resistance and diabetes. It has not been previously shown in humans to be related to or causative of impaired first phase insulin secretion response and/or specific beta cell dysfunction, although an in-vitro experiment on a beta cell line demonstrated that addition of AHB to culture medium decreased the amount of insulin the beta cells secreted in culture. (DeFronzo and Gall).

### Linoleoyl GPC

Linoleoyl GPC is a metabolite that has been correlated in the literature to impaired glucose disposal, the metabolic syndrome, and peripheral insulin resistance as measured by the clamp technique. It is used clinically together with AHB and OA to classify patients according to their glucose tolerance, i.e. NGT, IGT, etc. The level of linoleoyl GPC decreases with development of insulin resistance and diabetes but the mechanism is not understood.

### Oleic Acid (OA)

Oleic acid (OA) is a free fatty acid that makes up 80% of the free fatty acid pool in the blood. Levels may vary significantly in the blood of patients at various stages of T2DM development in insulin resistant patients, and OA increases with the progression of T2DM.

### Insulin Resistance (IR) Score

Insulin resistance (IR) Score, as referred herein, is derived from the alpha (a) hydroxybutyrate (AHB), linoleoyl glycerolphosphocholine (GPC), and oleic acid in addition to mathematical weighting with factors like insulin level. These biomarkers together form the Quantose™ IR diagnostic test developed by Metabolon, Inc. for measuring insulin resistance to detect prediabetes earlier and with greater sensitivity than traditional glycemic markers such as glucose and hemoglobin A1c. See U.S. Pat. No. 8,187,830 and U.S. Patent Application Publication Nos. 2012/0208215 A1 and 2012/0122981 A1.

### Inflammatory Markers

High Sensitivity C-Reactive Protein (hsCRP)

High sensitivity C-reactive protein (hsCRP) is a nonspecific inflammatory marker produced by the liver in response to inflammatory cytokines and macrophages. CRP may be elevated due to infection, autoimmune disease, or other inflammatory stimulus. CRP is a strong and independent risk marker for primary and secondary coronary heart disease (CHD) events, sudden death, stroke and peripheral vascular disease. Elevation of hsCRP is also associated with insulin resistance and metabolic syndrome. When CRP is elevated on repeated measurements, an acute cause is less likely and systemic inflammation such as that associated with atherosclerosis and diabetes is more likely. Evaluation of hsCRP together with other inflammatory biomarkers that are not acute phase reactants with demonstrated vascular specificity is useful. CRP may be lowered by making lifestyle changes, including weight reduction, low-fat diet, smoking cessation and regular exercise. A diet rich in plant sterols, soy protein, viscous fiber, and almonds has been shown to have CRP-lowering effects comparable to that of lovastatin 20 mg/day. Medications that may lower CRP include statins, fibrates, and fish oil. Reducing global CHD risk by aggressive treatment of the traditional risk factors by established therapies may also be beneficial.

### Myeloperoxidase (MPO)

Myeloperoxidase (MPO) is a marker of inflammation and oxidative processes that may lead to atherosclerotic plaque vulnerability as well as left ventricular remodeling. In apparently healthy individuals elevated values of MPO are associated with an approximate 2.0× increased risk for major adverse cardiovascular events (major adverse cardiac events (MACE); heart attack, stroke, or cardiovascular death). Risk ranges for prognosis in the absence of acute symptoms (chest discomfort, etc.), are shown in the report: >550 pmol/L=high risk; 400-549 pmol/L=intermediate risk; and <400 pmol/L=low risk. In the setting of chest pain or discomfort, markedly elevated values are associated with increased risk for MACE in the ensuing 6 months. Moreover, the relative risk for MACE increases with increasing levels of MPO. In the presence of chest discomfort, values <633 pmol/L are normal; 633-894 pmol/L=lower risk for near term MACE, 894-1,657=intermediate risk for MACE and values >1,657 pmol/L=high risk for MACE in the ensuing 6 months. Elevated MPO values in the setting of heart failure are associated with adverse events above and beyond (independently of) that of N-terminal probrain natriuretic peptide (NT-proBNP) concentration. MPO is on the outside of the vessel wall and is a leukocyte-derived enzyme that catalyzes the formation of oxidants and results in the formation of oxidized LDL, which is atherogenic.

### Lipoprotein-Associated Phospholipase A₂ (Lp-PLA₂)

Lipoprotein-associated phospholipase A₂ (Lp-PLA₂) is an inflammatory risk marker that, unlike hs-CRP, is not an acute phase reactant. LpPLA₂ is an enzyme responsible for the hydrolysis of oxidized phospholipid on LDL. It is a specific marker for vascular inflammation and is produced by macrophages and in unstable atherosclerotic plaque. Lp-PLA₂ is produced by macrophages and circulates in association with LDL particles. Inside the vessel wall, Lp-PLA₂, reacting with oxidized LDL, specifically cleaves oxidized phospholipids to produce bioactive intermediates (lysophosphatidylcholine and oxidized free fatty acids) that up regulate inflammation. Lp-PLA₂ is indicative of vulnerable plaque. Thus, when both MPO and Lp-PLA₂ are elevated, it creates a condition where oxidized phospholipids are formed, which can subsequently be cleaved to bioactive products that up regulate and maintain the inflammatory pathway.

Elevated levels of Lp-PLA₂ indicate a 2 fold increase risk for CVD events and ischemic stroke. High plasma Lp-PLA₂ is associated with increased risk for cardiovascular disease and events (myocardial infarction and stroke). Increased values have also been associated with endothelial dysfunction and peripheral arterial disease. Lp-PLA₂ is the only test that is FDA-approved to assess risk for stroke. Patients in the upper tertile for both CRP and Lp-PLA₂ are at highest risk. In the Atherosclerosis risks in communities (ARIC) study, patients with both CRP and Lp-PLA₂ in the upper tertile of the population had 5 times increased risk for myocardial infarction and 11 times increased risk for stroke. Statins, fibric acids, and niacin have been shown to have Lp-PLA₂ lowering effects.

### Fibrinogen

Fibrinogen is an acute phase soluble plasma glycoprotein that is synthesized primarily in the liver and converted by thrombin into fibrin during the blood coagulation process. Normal fibrinogen levels in blood are between 1.5 and 3.5 g/litre but can increase three-fold during acute phase stimulation (see Gordon et al., 1985), particularly in response to increased IL-6 production (Gabay et al., 1999, Mackiewicz et al., 1991). Fibrinogen increases in the context of inflammatory processes such as those leading to adverse cardiovascular events, e.g., MI and strokes. Increased fibrinogen may also be suggestive of acute infection/inflammation or other chronic inflammatory disease, which should be appropriately investigated; however, it is also associated with the onset of insulin resistance and T2DM. Data from prospective studies indicates that increased concentration of CRP or fibrinogen is associated with an increased risk for the development of ischemic cardiovascular events. Fibrinogen levels are reduced by smoking cessation, exercise, alcohol, and estrogens. The fibrates have significant fibrinogen-lowering effects but, at the present time, it is unknown whether reduction of fibrinogen levels will alter clinical outcomes. As defined herein, the term “fibrinogen” includes the parent protein, as well as its derivatives and degradation products, such as D-dimer and fibrinogen degradation products (FDP).

### Dyslipidemia

### Lipids and Lipoproteins

Despite evidence that dyslipidemia is associated with the development of the metabolic syndrome and T2DM, and despite multiple studies correlating this dyslipidemia to risk of cardiovascular disease in individuals with metabolic syndrome and diabetes, many thought leaders fail to measure or understand the contribution of dyslipidemia to cardiodiabetes disease development and progression. In his Banting Lecture, R. A. DeFronzo discussed how elevated free fatty acid levels impaired insulin secretion; however, there is no discussion of blood lipids and lipoproteins. The importance of dyslipidemia (beyond the customary LDL-c and HDL-c numbers as risk factors for cardiovascular disease) seems to have been largely ignored by many thought leaders in the field of diabetes research. (DeFronzo, R. A., Banting Lecture, From the triumvirate to the ominous octet: a new paradigm for the treatment of type 2 diabetes mellitus, Diabetes 58(4):773-795, 2009). Although is not the intention of the author to provide a review of the body of literature supporting the relationship of dyslipidemia to metabolic syndrome and diabetes and cardiovascular disease development thereof. Thus, according to the embodiment of the invention, lipid and lipoprotein-related biomarkers for the sub-panel and super panel are based on their individual and composite predictive value (far beyond LDL-c and HDL-c) in determining risk of development of cardiodiabetes, as well as for their use in selection of appropriate therapy and monitoring.

As an example, approximately half of patients who develop CAD and suffer MI have normal HDL-c and/or LDL-c. Current guidelines recommend an LDL-C goal of <100 mg/dl for all diabetic patients, and an optional goal of <70 mg/dl in patients with diabetes with known CVD. However, many patients with normal or optimal LDL-C develop atherosclerosis and CAD. Studies often reveal that T2DM patients and patients with metabolic syndrome have elevated LDL particle numbers (LDL-P), which are not ordered by most clinicians or measured by most diagnostic companies. LDL-p number and size are actually better correlated to risk of cardiodiabetes than the more commonly measured analytes (Malave, 2012). This is also known to be the case for HDL, wherein HDL-c correlates very poorly to cardiovascular risk, whereas HDL-p number and size correlate much better. In fact, small, dense HDL (HDL3) is known to play a key role in fighting intravascular inflammation and oxidative processes; the lack of sdHDL and its associated anti-oxidative anti-inflammatory activity in metabolic syndrome and diabetes is related to the development of atherogenic dyslipidemia, and is linked to the constellation of risk factors including hypertriglyceridemia, hyperglycemia, hyperinsulinemia, insulin resistance, and increased atherogenic ApoB with decreased anti-atherogenic HDL (Kontush, A. et al., 2006). The data described herein has identified lipids and lipoproteins not previously related specifically to cardiodiabetic risk, and it is believed that these have never been run together in a panel for the purpose of diagnosing, monitoring, and prognosing cardiodiabetes risk, particularly in combination with the other unique biomarkers in other panels.

### Remnant-Like Lipoprotein Particles (RLPs)

Remnant-Like Lipoprotein Particles (RLPs) and their associated cholesterol measures (RLP-c) are plasma lipoproteins that contribute to atherosclerosis. RLPs are generated from the breakdown of very low density lipoprotein (VLDL), intermediate density lipoprotein (IDL) or low density lipoprotein (LDL), are rich in triglycerides, and are highly atherogenic. These particles have similar atherogenic and inflammatory properties to oxidized LDL (ox-LDL). It has been suggested that especially in patients with metabolic syndrome, reducing plasma RLPs by therapy for hyperlipidemia may prevent endothelial dysfunction and the development of atherosclerosis (Nakajima et al., 2006). Very few laboratories measure RLP number or associated lipid content and no other clinical laboratory measures RLP or RLP-c in conjunction with the extensive panel of biomarkers of dyslipidemia detailed in Table 2 and Table 3. Also, RLPs or RLPc assays or measurements are unavailable for diagnosis, prognosis, treatment guidance, or therapy monitoring for cardiodiabetes in the context of the other sub-panels described herein. Thus, the measurement of RLPs and RLP-c in conjunction with these other biomarkers and biomarker panels may offer additional advantage over traditional assays and are clinically actionable in assessing risk of cardiodiabetes, presence of cardiodiabetes, and in the selection of therapy, and monitoring of the condition.

### Free Fatty Acids (FFAs)

Free Fatty Acids (FFAs) are indicative of dyslipidemia when they are elevated, and are known to cause insulin resistance in adipose tissue and muscle tissue. An elevated total FFA alone does not imply risk of cardiodiabetes or poor glycemic control; however, when measured in the context of other biomarkers comprising abnormal glycemic control, beta cell dysfunction, insulin resistance, and/or inflammation, the elevated FFAs can then be interpreted together with the other biomarkers to categorize cardiodiabetes risk, either by classification of cardiodiabetes risk by categorical risk level (low/optimal, intermediate, high), or by the incorporation of FFA into a risk score.

### Triglycerides (Trigs)

Triglycerides are a type of lipid that enable transference of adipose fat and blood glucose from the liver to the bloodstream; they are exported by the liver particularly in the case of diets high in carbohydrate and when blood glucose is high such as in the case of patients with impaired glucose tolerance and diabetes. It is thought that triglycerides may be related to hepatic insulin resistance (for instance, in NAFLD and NASH that occur at very high frequency in diabetics and people with metabolic syndrome). High levels of triglycerides in the bloodstream have been linked to atherosclerosis and, and increased risk of heart disease and stroke. There is a marked inverse relationship between triglyceride level and HDL-cholesterol level, which is evidence that triglycerides are not only part of the glycemic control axis, but a lipid that is indeed linked mechanistically to the other lipids and lipoproteins as well. For this reason triglycerides alone give some information about risk of cardiodiabetes, but give more information when combined with biomarkers from other categories as claimed.

### Apolipoprotein B-48 (ApoB-48)

ApoB-48 is one of the 2 main isoforms of Apolipoprotein B. ApoB48 is synthesized exclusively by the small intestine, while ApoB-100 (aka ApoB) is synthesized by the liver. ApoB48 shares 48% of ApoB100's sequence, except for the C-terminal LDL receptor binding region. Therefore ApoB-48 does not bind to LDL receptor and it has a different physiological role than ApoB.

ApoB 48 protein is unique protein to chylomicrons from the small intestine; after most of the lipids in a chylomicron have been absorbed, ApoB48 in the bloodstream returns to the liver as part of the chylomicron remnant, where it is endocytosed and degraded independent of the LDL receptor. Therefore the ApoB-48 lipoprotein is unique in its origin because it is the only lipoprotein produced by the gut (which also produces the incretin hormones such as GLP-1 and GIP). Mixed hyperlipidemia is common in patients with diabetes and ApoB-48 is frequently elevated in these patients, contributing significantly to cardiodiabetes risk. Drugs that reduce levels of lipoproteins that contain apolipoproteinB 100, like statins, fail to effectively lower levels of lipoproteins like ApoB-48 that are also atherogenic. High levels of ApoB-48, particularly in diabetic patients, can be treated with omega 3 fatty acids and fluvastatin. The fact that ApoB-48 does not respond to statins like other ApoB-containing lipoproteins underscores the uniqueness of this lipid and the novelty of inclusion of this analyte into the dyslipidemia panel. Interestingly, a correlation in the results obtained herein is observed, a clustering, of ApoB-48 with D-mannose, which is related to hepatic insulin resistance. This lipid may therefore be elevated in patients with impaired glucose tolerance due to hepatic insulin resistance which impairs its uptake and recycling, thus contributing to atherosclerosis in particular and cardiodiabetes in general.

### Linoleoyl-Glycerophosphocholine (L-GPC)

L-GPC is a lipid, a glycerophosphocholine conjugate that has been correlated in the literature to impaired glucose disposal, the metabolic syndrome, and peripheral insulin resistance as measured by the clamp technique. It is used clinically together with AHB and OA to classify patients according to their glucose tolerance, i.e. NGT, IGT, etc. The level of Linoleoyl GPC decreases with development of insulin resistance and diabetes but the mechanism is not understood. L-GPC is known to enhance insulin secretion in vitro by a beta cell line when added to culture media.

### LP-IR

LP-IR score is a measure of insulin resistance derived from measurements of lipoprotein particle sizes and numbers. It is a measure of insulin resistance, therefore, that is based purely on dyslipidemic factors and no others. A patient may have an LP-IR score that indicates that they are insulin resistance, while all biomarkers of glycemic control, beta dysfunction and other IR markers are normal; the converse may also be true. Therefore the LP-IR score, and its components, give information on only one dimension of cardiodiabetes risk. Combining this score or its component values with additional biomarkers drawn from the claimed groups is more sensitive and specific for measuring cardiodiabetes risk.

For the purposes of the rest of this invention disclosure, “cardiodiabetes” is defined as any condition related to the development and initiation of the diabetic disease process or cardiovascular disease, or complications arising therefrom, including but not limited to the following: insulin resistance, metabolic syndrome, type 2 diabetes mellitus (T2DM), type 1 diabetes mellitus (T1DM), fatty liver, diabetic nephropathy, diabetic neuropathy, vasculitis, atherosclerosis, coronary artery disease (CAD), vulnerable plaque formation, myocardial infarction (MI), cardiomyopathy, endothelial dysfunction, hypertension, occlusive stroke, ischemic stroke, transient ischemic event (TIA), deep vein thrombosis (DVT), dyslipidemia, gestational diabetes (GDM), periodontal disease, obesity, morbid obesity, chronic and acute infections, pre-term labor, diabetic retinopathy, and systemic or organ-specific inflammation.

Patients with insulin resistance and β-cell dysfunction without elevation of blood glucose are not identified as suffering from diabetes mellitus. These normoglycemic patients, however, experience the same elevated cardiovascular risk, which is predominantly linked to vascular insulin resistance. This condition is newly referred to as “cardiodiabetes” or “cardiocardiodiabetes.” The term “metabolic syndrome” may also be used herein to refer to this condition. A cardiodiabetic subject might not exhibit one or more of the normal symptoms of diabetes including, but not limited to, hyperglycemia, fatigue, unexplained weight loss, excessive thirst, excessive urination, excessive eating, poor wound healing, infections, altered mental status and blurry vision. A cardiodiabetic subject is at high risk for cardiovascular disease and may experience events such as myocardial infarction and stroke. That is, diabetes mellitus, cardiodiabetes and metabolic syndrome are phenotypes of a common underlying pathophysiology.

“Diabetic dyslipidemia” or “Type II diabetes with dyslipidemia” means a condition characterized by Type II diabetes, reduced HDL, elevated serum triglycerides, and elevated small, dense LDL particles.

The term “hyperglycemia” refers to elevated blood glucose levels in the body, which results from metabolic defects in production and utilization of glucose. A subject is identified as hyperglycemic if the subject has a fasting blood glucose level that consistently exceeds 126 mg/d1.

As used herein, “hypoglycemia” is a lower than normal blood glucose concentration, usually less than 63 mg/dL 3.5 mM). Clinically relevant hypoglycemia is defined as blood glucose concentration below 63 mg/dL or causing patient symptoms such as hypotonia, flush and weakness that are recognized symptoms of hypoglycemia and that disappear with appropriate caloric intake. Severe hypoglycemia is defined as a hypoglycemic episode that required glucagon injections, glucose infusions, or help by another party.

The term “diabetic condition” refers to a condition characterized by impaired glucose production and/or utilization and includes diabetes mellitus (e.g., type 1 diabetes mellitus (T1DM), type 2 diabetes mellitus (T2DM), and gestational diabetes), pre-diabetes, metabolic syndrome, hyperglycemia, impaired glucose tolerance, impaired fasting glucose, cardiodiabetes, latent autoimmune diabetes of adults (LADA) and atypical forms of Type I diabetes such as insulin autoimmune syndrome (IAS).

As used herein, the term “cardiovascular diseases” refer to the class of diseases that involve the heart, blood vessels (arteries and veins) or the circulation. Examples of cardiovascular diseases include, but are not limited to, hypertension, aneurysm, angina, arrhythmia, coronary heart disease, heart failure, congestive heart failure, atherosclerosis, arteriosclerosis, dyslipidemia, hyperlipidemia, hypercholesterolemia, stroke, cerebrovascular disease, myocardial infarction and peripheral vascular disease.

“Dyslipidemia” refers to a disorder of lipid and/or lipoprotein metabolism, including lipid and/or lipoprotein overproduction or deficiency. Dyslipidemias may be manifested by elevation of the triglyceride concentrations, and a decrease in the “good” high-density lipoprotein (HDL) cholesterol concentration in the blood.

“Diabetic dyslipidemia” or “Type II diabetes with dyslipidemia” refers to a condition characterized by Type II diabetes mellitus, reduced HDL-C, elevated serum triglycerides, and elevated small, dense LDL particles. For adults with diabetes, it has been recommended that the levels HDL-cholesterol, and triglyceride be measured every year. Optimal HDL-cholesterol levels are equal to or greater than 40 mg/dL (1.02 mmol/L), and desirable triglyceride levels are less than 150 mg/dL (1.7 mmol/L).

“Mixed dyslipidemia” means a condition characterized by elevated serum cholesterol and elevated serum triglycerides.

“Elevated total cholesterol” means total cholesterol at a concentration in an individual at which lipid-lowering therapy is recommended, and includes, without limitation, “elevated LDL-C”, “elevated VLDL-C,” “elevated IDL-C” and “elevated non-HDL-C.” Total cholesterol concentrations of less than 200 mg/dL, 200-239 mg/dL, and greater than 240 mg/dL are considered desirable, borderline high, and high, respectively. In certain embodiments, LDL-C concentrations of 100 mg/dL, 100-129 mg/dL, 130-159 mg/dL, 160-189 mg/dL, and greater than 190 mg/dL are considered optimal, near optimal/above optimal, borderline high, high, and very high, respectively.

“Elevated lipoprotein” means a concentration of lipoprotein in a subject at which lipid-lowering therapy is recommended.

“Elevated triglyceride” means a concentration of triglyceride in the serum or liver at which lipid-lowering therapy is recommended, and includes “elevated serum triglyceride” and “elevated liver triglyceride.” n certain embodiments, triglyceride concentration of 150-199 mg/dL, 200-499 mg/dL, and greater than or equal to 500 mg/dL is considered borderline high, high, and very high, respectively.

“High density lipoprotein-C(HDL-C)” means cholesterol associated with high density lipoprotein particles. Concentration of HDL-C in serum (or plasma) is typically quantified in mg/dL or nmol/L. “Serum HDL-C” and “plasma HDL-C” mean HDL-C in the serum and plasma, respectively.

“Hypercholesterolemia” means a condition characterized by elevated cholesterol or circulating (plasma) cholesterol, LDL-cholesterol and VLDL-cholesterol, as per the guidelines of the Expert Panel Report of the National Cholesterol Educational Program (NCEP) of Detection, Evaluation of Treatment of high cholesterol in adults (see, Arch. Int. Med. (1988) 148, 36-39). Hypercholesterolemia is manifested by elevation of the total cholesterol due to elevation of the “bad” low-density lipoprotein (LDL) cholesterol in the blood. Optimal LDL-cholesterol levels for adults with diabetes are less than 100 mg/dL (2.60 mmol/L).

“Hyperlipidemia” or “hyperlipemia” is a condition characterized by elevated serum lipids or circulating (plasma) lipids. This condition manifests an abnormally high concentration of fats. The lipid fractions in the circulating blood are cholesterol, low density lipoproteins, very low density lipoproteins and triglycerides.

“Hypertriglyceridemia” means a condition characterized by elevated triglyceride levels.

The term “subject” as used herein includes, without limitation, mammals, such as humans or non-human animals. Non-human animals may include non-human primates, farm animals, sports animals, rodents or pets. A typical subject is human and may be referred to as a patient. Mammals other than humans can be advantageously used as subjects that represent animal models of the cardiovascular disease or for veterinarian applications.

A “biological sample” encompasses a variety of sample types obtained from a subject with a biological origin. Typically used here is a biological fluid sample including, but not limited to, blood, cerebral spinal fluid (CSF), interstitial fluid, urine, sputum, saliva, mucous, stool, lymphatic, or any other secretion, excretion, or and other bodily liquid samples. Exemplary biological fluid sample can be a blood component such as plasma, serum, red blood cells, whole blood, platelets, white blood cells, or components or mixtures thereof.

These biomarkers from a subject can be measured, detected and analyzed using various assays, methods and detection systems known to one of skill in the art. Methods to measure or detect levels of biomarkers include, but are not limited to, mass spectrometry (MS), gas chromatography (GC), liquid chromatography (LC), matrix-assisted laser desorption ionization-time of flight (MALDI-TOF), ion spray spectroscopy, ultra-violet spectroscopy (UV-vis), fluorescence analysis, radiochemical analysis, near-infrared spectroscopy (near-IR), infrared (IR) spectroscopy, nuclear magnetic resonance spectroscopy (NMR), light scattering analysis (LS), and combinations thereof. For instance, a rapid and high-throughput measurement and analysis of sterols/stanols or derivatives using liquid chromatography tandem mass spectrometry (LC-MS/MS) has been described in detail in U.S. Provisional Application No. 61/696,613, entitled, “Rapid and High-throuput Analysis of Sterols/stanols or Derivatives Thereof,” filed Sep. 4, 2012, which is herein incorporated by reference in its entirety.

The term “measure” refers to a quantitative or qualitative determination of the amount or concentration of a molecule or a substance. The term “level,” “amount,” or “concentration” can refer to an absolute or relative quantity. The level of each biomarker can be compared to a reference level of the corresponding biomarker, and the difference, if any, in the measured level of the biomarker in the subject compared to the reference level is then identified. This difference is used to determine the risk value or risk category as described herein

As used herein, a “reference value” or “reference level” can be an absolute value; a relative value; a value that has an upper and/or lower limit; a range of values; an average value; a median value, a mean value, or a value as compared to a particular control or baseline value. A reference value can be based on an individual sample value, such as for example, a value obtained from a sample from the subject being tested, but at an earlier point in time. The reference value can be based on a large number of samples, such as from population of healthy subjects, or based on a pool of samples including or excluding the sample to be tested.

The test results of each biomarker of a biomarker panel can be associated with a set of categorical risk level, for example, cardiodiabetes categorical risk level, cardiovascular categorical risk level or diabetes categorical risk level. Each cardiodiabetes categorical risk level (e.g., categorical risk level of optimal (low risk), intermediate (elevated risk) or high risk) may be associated with one or more biomarker provided in the patient-specific cardiodiabetes health report. Thus, by correlating a test result of a biomarker or concentration measurement of a biomarker panel with a particular set categorical risk level, for example, cardiodiabetes categorical risk level, the practitioner can classify the condition or disease state of a patient and recommend a therapy regimen to facilitate diagnosis, optimize therapy and lower the patient's cardiodiabetes risk. The risk categories and the boundaries dividing them for any biomarker are not limited to those disclosed herein and can be found in the art.

According to the embodiment of the invention, the therapy regimen chosen by a physician, practitioner or health provider can depend on the patient-specific cardiodiabetes health report. the patient-specific cardiodiabetes health report includes a cardiodiabetes categorical risk level for assessing the cardiodiabetic health significance of the test results of each of the biomarker test or a plurality of biomarker tests from each of the biomarker panel. A cardiodiabetes categorical risk level is assigned based on a comparison of the biomarker test results of the patient with a reference value range. In various exemplary embodiments, the therapy regimen may depend on which category from a range of categories particular to each biomarker the measured concentration or levels of each biomarker falls in. In various exemplary embodiments, the therapy regimen may depend on the combination of risk levels for different symptoms or diseases that are indicated by a biomarker panel.

The quantity or activity measurements of each of the biomarker test for each biomarker panel of the subject can be compared to a reference value. Differences in the measurements of biomarkers in the subject sample compared to the reference value are then identified and a categorical risk value is assigned.

In one embodiment, methods according to the invention may also involve administering the selected therapy regimen to the subject to reduce the risk of a diabetes disorder or cardiovascular disease or any complications thereof.

Yet another aspect of the invention relates to a method of prognosing, diagnosing, and/or predicting risk of diabetes and cardiovascular disease in a subject. This method is based on the results of determining the categorical risk level of Glycemic Control, Beta Cell Dysfunction, Insulin Resistance, Inflammation, and Dyslipidemia based on concentration measurements of biomarkers, analytes and calculated scores in the biomarker panel tests. As described above, abnormal intermediate or high-risk measurement(s) in any of these categories correlates with increase in patient risk for having or developing diabetes and cardiovascular disease or disorders.

For any given single biomarker panel, therapeutic intervention may be triggered or selected based on at least one, at least two, at least three, at least four, at least five, at least six, at least seven, at least eight, at least nine, at least ten, at least eleven, at least twelve, or at least thirteen biomarkers or analytes or scores falling within an medium (abnormal intermediate) or high risk category range. As referred herein, a reference index value range that defines risk categories may be one according to recognized standards for diagnostic cutoffs and risk calculation.

Therapeutic intervention may be triggered or selected based on at least one, at least two, at least three, at least four, or at least five members of the 5 specified biomarker panel tests that display data for measured analytes or calculated scores falling within an intermediate and/or a high risk category range, as described above. As noted above, the reference index value range that defines risk categories may be one according to recognized standards for diagnostic cutoffs and risk calculation.

Accordingly, the method also involves selecting a therapy regimen based on the results of determining the risk level of Glycemic Control, Beta Cell Dysfunction, Insulin Resistance, Inflammation, and Dyslipidemia based on measurements of analytes and calculated scores in those panel tests. As described above, abnormal intermediate or high-risk measurement(s) in any of these categories correlates with increase in patient risk for having or developing cardiodiabetes (e.g. diabetes and cardiovascular disease or disorders or complications thereof).

A therapy regimen includes, for example, drugs or supplements. The drug or supplement may be any suitable drug or supplement useful for the treatment or prevention of diabetes and related cardiovascular disease or disorders or complications thereof. Examples of suitable agents may include an anti-inflammatory agent, an antithrombotic agent, an anti-platelet agent, a fibrinolytic agent, a lipid reducing agent, a direct thrombin inhibitor, a glycoprotein IIb/IIIa receptor inhibitor, an agent that binds to cellular adhesion molecules and inhibits the ability of white blood cells to attach to such molecules, a PCSK9 inhibitor, an MTP inhibitor, mipmercin, a calcium channel blocker, a beta-adrenergic receptor blocker, an angiotensin system inhibitor, a glitazone, a GLP-1 analog, thiazolidinedionones, biguanides, neglitinides, alpha glucosidase inhibitors, insulin, a dipeptidyl peptidase IV inhibitor, metformin, a sulfonurea, peptidyl diabetic drugs such as pramlintide and exenatide, or combinations thereof. The agent is administered in an amount effective to treat the cardiovascular disease or disorder or to lower the risk of the subject developing a future cardiovascular disease or disorder.

A therapy regimen may also include treatment for chronic infections such as urinary tract infections (UTIs), reproductive tract infections, and periodontal disease. Therapies may include appropriate antibiotics and/or other drugs, and surgical procedures and/or dentifrice for the treatment of periodontal disease.

A therapy regimen may include referral to a healthcare specialist or related specialist based on the determining of risk levels. The determining may cause referral to a cardiologist, endocrinologist, ophthalmologist, lipidologist, weight loss specialist, registered dietician, health coach, personal trainer, etc. Further therapeutic intervention by specialists based on the determining may take the form of cardiac catherization, stents, imaging, coronary bypass surgeries, EKG, Doppler, hormone testing and adjustments, weight loss regimens, changes in exercise routine, diet, and other personal lifestyle habits.

Anti-inflammatory agents may include but are not limited to, Aldlofenac; Aldlometasone Dipropionate; Algestone Acetonide; Alpha Amylase; Amcinafal; Amcinafide; Amfenac Sodium; Amiprilose Hydrochloride; Anakinra; Anirolac; Anitrazafen; Apazone; Balsalazide Disodium; Bendazac; Benoxaprofen; Benzydamine Hydrochloride; Bromelains; Broperamole; Budesonide; Carprofen; Cicloprofen; Cintazone; Cliprofen; Clobetasol Propionate; Clobetasone Butyrate; Clopirac; Cloticasone Propionate; Cormethasone Acetate; Cortodoxone; Deflazacort; Desonide; Desoximetasone; Dexamethasone Dipropionate; Diclofenac Potassium; Diclofenac Sodium; Diflorasone Diacetate; Diflumidone Sodium; Diflunisal; Difluprednate; Diftalone; Dimethyl Sulfoxide; Drocinonide; Endrysone; Enlimomab; Enolicam Sodium; Epirizole; Etodolac; Etofenamate; Felbinac; Fenamole; Fenbufen; Fenclofenac; Fenclorac; Fendosal; Fenpipalone; Fentiazac; Flazalone; Fluazacort; Flufenamic Acid; Flumizole; Flunisolide Acetate; Flunixin; Flunixin Meglumine; Fluocortin Butyl; Fluorometholone Acetate; Fluquazone; Flurbiprofen; Fluretofen; Fluticasone Propionate; Furaprofen; Furobufen; Halcinonide; Halobetasol Propionate; Halopredone Acetate; Ibufenac; Ibuprofen; Ibuprofen Aluminum; Ibuprofen Piconol; Ilonidap; Indomethacin; Indomethacin Sodium; Indoprofen; Indoxole; Intrazole; Isoflupredone Acetate; Isoxepac; Isoxicam; Ketoprofen; Lofemizole Hydrochloride; Lomoxicam; Loteprednol Etabonate; Meclofenamate Sodium; Meclofenamic Acid; Meclorisone Dibutyrate; Mefenamic Acid; Mesalamine; Meseclazone; Methylprednisolone Suleptanate; Momiflumate; Nabumetone; Naproxen; Naproxen Sodium; Naproxol; Nimazone; Olsalazine Sodium; Orgotein; Orpanoxin; Oxaprozin; Oxyphenbutazone; Paranyline Hydrochloride; Pentosan Polysulfate Sodium; Phenbutazone Sodium Glycerate; Pirfenidone; Piroxicam; Piroxicam Cinnamate; Piroxicam Olamine; Pirprofen; Prednazate; Prifelone; Prodolic Acid; Proquazone; Proxazole; Proxazole Citrate; Rimexolone; Romazarit; Salcolex; Salnacedin; Salsalate; Salycilates; Sanguinarium Chloride; Seclazone; Sermetacin; Sudoxicam; Sulindac; Suprofen; Talmetacin; Talniflumate; Talosalate; Tebufelone; Tenidap; Tenidap Sodium; Tenoxicam; Tesicam; Tesimide; Tetrydamine; Tiopinac; Tixocortol Pivalate; Tolmetin; Tolmetin Sodium; Triclonide; Triflumidate; Zidometacin; Glucocorticoids; or Zomepirac Sodium.

Anti-thrombotic and/or fibrinolytic agents may include but are not limited to, Plasminogen (to plasmin via interactions of prekallikrein, kininogens, Factors XII, XIIIa, plasminogen proactivator, and tissue plasminogen activator[TPA]), Streptokinase; Urokinase: Anisoylated Plasminogen-Streptokinase Activator Complex; Pro-Urokinase; (Pro-UK); rTPA (alteplase or activase; r denotes recombinant); rPro-UK; Abbokinase; Eminase; Sreptase Anagrelide Hydrochloride; Bivalirudin; Dalteparin Sodium; Danaparoid Sodium; Dazoxiben Hydrochloride; Efegatran Sulfate; Enoxaparin Sodium; Ifetroban; Ifetroban Sodium; Tinzaparin Sodium; retaplase; Trifenagrel; Warfarin; Dextrans; and Heparin.

Anti-platelet agents may include but are not limited to, Clopridogrel; Sulfinpyrazone; Aspirin; Dipyridamole; Clofibrate; Pyridinol Carbamate; PGE; Glucagon; Antiserotonin drugs; Caffeine; Theophyllin Pentoxifyllin; Ticlopidine; and Anagrelide.

Lipid-reducing agents include but are not limited to, gemfibrozil, cholystyramine, colestipol, nicotinic acid, probucol lovastatin, fluvastatin, simvastatin, atorvastatin, pravastatin, cerivastatin, and other HMG-CoA reductase inhibitors.

Direct thrombin inhibitors may include, but are not limited to, hirudin, hirugen, hirulog, agatroban, PPACK, and thrombin aptamers.

Glycoprotein IIb/IIIa receptor inhibitors are both antibodies and non-antibodies, and may include, but are not limited to, ReoPro (abcixamab), lamifiban, and tirofiban.

Calcium channel blockers are a chemically diverse class of compounds having important therapeutic value in the control of a variety of diseases including several cardiovascular disorders, such as hypertension, angina, and cardiac arrhythmias. Calcium channel blockers are a heterogenous group of drugs that prevent or slow the entry of calcium into cells by regulating cellular calcium channels (see REMINGTON, THE SCIENCE AND PRACTICE OF PHARMACY, 21st Edition, Mack Publishing Company, 2005, which is hereby incorporated by reference in its entirety). Most of the currently available calcium channel blockers belong to one of three major chemical groups of drugs, the dihydropyridines, such as nifedipine, the phenyl alkyl amines, such as verapamil, and the benzothiazepines, such as diltiazem. Other calcium channel blockers may include, but are not limited to, anrinone, amlodipine, bencyclane, felodipine, fendiline, flunarizine, isradipine, nicardipine, nimodipine, perhexilene, gallopamil, tiapamil and tiapamil analogues (such as 1993RO-11-2933), phenytoin, barbiturates, and the peptides dynorphin, omega-conotoxin, and omega-agatoxin, and the like and/or pharmaceutically acceptable salts thereof.

Beta-adrenergic receptor blocking agents are a class of drugs that antagonize the cardiovascular effects of catecholamines in angina pectoris, hypertension, and cardiac arrhythmias. Beta-adrenergic receptor blockers may include, but are not limited to, atenolol, acebutolol, alprenolol, beftunolol, betaxolol, bunitrolol, carteolol, celiprolol, hedroxalol, indenolol, labetalol, levobunolol, mepindolol, methypranol, metindol, metoprolol, metrizoranolol, oxprenolol, pindolol, propranolol, practolol, practolol, sotalolnadolol, tiprenolol, tomalolol, timolol, bupranolol, penbutolol, trimepranol, 2-(3-(1,1-dimethylethyl)-amino-2-hydroxypropoxy)-3-pyridenecarbonitrilHCl, 1-butylamino-3-(2,5-dichlorophenoxy)-2-propanol, 1-isopropylamino-3-(4-(2-cyclopropylmethoxyethyl)phenoxy)-2-propanol, 3-isopropylamino-1-(7-methylindan-4-yloxy)-2-butanol, 2-(3-t-butylamino-2-hydroxy-propylthio)-4-(5-carbamoyl-2-thienyl)thiazol, 7-(2-hydroxy-3-t-butylaminpropoxy)phthalide. The above-identified compounds can be used as isomeric mixtures, or in their respective levorotating or dextrorotating form.

An angiotensin system inhibitor is an agent that interferes with the function, synthesis or catabolism of angiotensin II. These agents are well known to those of ordinary skill in the art and may include but are not limited to, angiotensin-converting enzyme (“ACE”) inhibitors, angiotensin II antagonists, angiotensin II receptor antagonists, agents that activate the catabolism of angiotensin II, and agents that prevent the synthesis of angiotensin I from which angiotensin II is ultimately derived. The renin-angiotensin system is involved in the regulation of hemodynamics and water and electrolyte balance. Factors that lower blood volume, renal perfusion pressure, or the concentration of Na+ in plasma tend to activate the system, while factors that increase these parameters tend to suppress its function.

Angiotensin (renin-angiotensin) system inhibitors are compounds that act to interfere with the production of angiotensin II from angiotensinogen or angiotensin I or interfere with the activity of angiotensin II. Such inhibitors are well known to those of ordinary skill in the art and, may include but are not limited to, compounds that act to inhibit the enzymes involved in the ultimate production of angiotensin II, including renin and ACE. They also include compounds that interfere with the activity of angiotensin II, once produced. Examples of classes of such compounds, may include antibodies (e.g., to renin), amino acids and analogs thereof (including those conjugated to larger molecules), peptides (including peptide analogs of angiotensin and angiotensin I), pro-renin related analogs, etc. Among the most potent and useful renin-angiotensin system inhibitors, may include but are not limited to, renin inhibitors, ACE inhibitors, and angiotensin II antagonists, which are well known to those of ordinary skill in the art.

Examples of drugs that act to interfere with PSK9's interaction with LDL receptors may include but are not limited to, Aln-PCS (Alnylam); REG 727 (Regeneron); and AMG-145 (Amgen).

The drugs and/or supplements (i.e., therapeutic agents) can be administered via any standard route of administration known in the art, including, but not limited to, parenteral (e.g., intravenous, intraarterial, intramuscular, subcutaneous injection, intrathecal), oral (e.g., dietary), topical, transmucosal, or by inhalation (e.g., intrabronchial, intranasal or oral inhalation, intranasal drops). Typically, oral administration is the preferred mode of administration.

A therapy regimen may also include giving recommendations on making or maintaining lifestyle choices useful for the treatment or prevention of diabetes and cardiovascular disease based on the results of determining the amounts of analytes and calculated scores and their associated risk levels in the subject. The lifestyle choices can involve changes in diet, changes in exercise, reducing or eliminating smoking, or a combination thereof. For example, the therapy regimen, may include but are not limited to, glucose control, lipid metabolism control, weight loss control, and smoking cessation. As will be understood, the lifestyle choice is one that will affect risk for developing or having a cardiovascular disease or disorder (see Haskell et al., “Effects of Intensive Multiple Risk Factor Reduction on Coronary Atherosclerosis and Clinical Cardiac Events in Men and Women with Coronary Artery Disease,” Circulation 89(3):975-990 (1994); Ornish et al., “Intensive Lifestyle Changes for Reversal of Coronary Heart Disease,” JAMA 220(23): 2001-2007 (1998); and Wister et al., “One-year Follow-up of a Therapeutic Lifestyle Intervention Targeting Cardiovascular Disease Risk,” CMAJ 177(8):859-865 (2007), which are hereby incorporated by reference in their entirety).

Reports based on the results of determining the subject's diabetes and related cardiovascular disease risk may be generated. The reports may include suggested therapy regimens selected based on the subject's diabetes and cardiovascular disease risk. This report may be transmitted or distributed to a patient's doctor or directly to the patient. Following transmission or distribution of the report, the subject may be coached or counseled based on the therapy recommendations.

A health practitioner may generally refer to any individual that is trained to provide health care services, including, but are not limited to, a physician, physician assistant, nurse, midwife, dietitian, therapist, psychologist, pharmacist, clinical officer, phlebotomist, emergency medical technician, medical laboratory scientist, medical prosthetic technician, social worker, community health worker, and a wide variety of other human resource trained to provide some type of health care service. Health practitioners can work in hospitals, health care centers, or other service delivery points, including care and treatment services in private homes; or in academic training, research, and administration.

Treating the subject involves administering to the subject an agent suitable to treat a diabetes, or cardiovascular disease or disorder or to lower the risk of a subject developing a future diabetes or cardiovascular disease or disorder. Suitable agents include an anti-inflammatory agent, an antithrombotic agent, an anti-platelet agent, a fibrinolytic agent, a lipid reducing agent, a direct thrombin inhibitor, a glycoprotein IIb/IIIa receptor inhibitor, an agent that binds to cellular adhesion molecules and inhibits the ability of white blood cells to attach to such molecules, a PCSK9 inhibitor, an MTP inhibitor, mipmercin, a calcium channel blocker, a beta-adrenergic receptor blocker, an angiotensin system inhibitor, a glitazone, a GLP-1 analog, thiazolidinedionones, biguanides, neglitinides, alpha glucosidase inhibitors, an insulin, a dipeptidyl peptidase IV inhibitor, metformin, a sulfonurea, peptidyl diabetic drugs such as pramlintide and exenatide, or combinations thereof. The agent is administered in an amount effective to treat the cardiovascular disease or disorder or to lower the risk of the subject developing a future cardiovascular disease or disorder.

A therapy regimen may also include treatment for chronic infections such as UTIs, reproductive tract infections, and periodontal disease. Therapies may include appropriate antibiotics and/or other drugs, and surgical procedures and/or dentifrice for the treatment of periodontal disease.

A therapy regimen may include referral to a healthcare specialist or related specialist based on the determining of risk levels. The determining may cause referral to a cardiologist, endocrinologist, opthamologist, lipidologist, weight loss specialist, registered dietician, “health coach”, personal trainer, etc. Further therapeutic intervention by specialists based on the determining may take the form of cardiac catherization, stents, imaging, coronary bypass surgeries, EKG, Doppler, hormone testing and adjustments, weight loss regimens, changes in exercise routine, diet, and other personal lifestyle habits.

The methods may include monitoring the status of diabetes and cardiovascular disease state or risk in a subject or the effects of therapeutic agents on subjects with cardiovascular disease. Monitoring may involve determining the risk levels in analytes and scores (measured within a panel or multiple panels as described above) in a subject's biological samples taken from the subject over time (e.g., before and after therapy). For example, an increase in function for one or more analytes on one or more panels (improvement in risk level) in a biological sample taken at the subsequent time as compared to the initial time indicates that a subject's risk of developing diabetes or a cardiovascular disease is decreased. A deterioration in function of one or more analytes on one or more panels (elevation of risk level) indicates that the subject's risk of having diabetes or a cardiovascular disease is increased. Monitoring may also include determining success of treatment(s) for infection and inflammation, and acting on said determining to affect resolution of the condition. For example, treatment of periodontitis to resolution by antibiotics, surgical procedure and hygienic dentifrice (improvement in risk level) would indicate that the subject's risk of having diabetes or a cardiovascular disease is decreased.

Monitoring can also assess the risk for developing diabetes and cardiovascular disease. This method involves determining if the subject is at an elevated risk for developing diabetes and cardiovascular disease, which may include assigning the subject to a risk category selected from the group consisting of high risk, intermediate risk, and low risk (i.e., optimal) groups for developing or having diabetes or cardiovascular disease. This method also involves repeating the determining if the subject is at an elevated risk for developing diabetes and cardiovascular disease after a period of time (e.g., before and after therapy). The method may also involve comparing the first and second risk categories determining, based on the comparison, if the subject's risk for developing diabetes and cardiovascular disease has increased or decreased, thereby monitoring the risk for developing diabetes and cardiovascular disease.

The physical structure is a combination of diagnostic analytes predictive for the conditions above that can aid in diagnsosis and therapy guidance, arranged in panels on a report seen by a healthcare provider or patient. For each analyte in each panel, the measured level derived from the patient sample is compared to known references ranges and the corresponding level of risk is assigned. The measures of risk for development of insulin resistance, diabetes, and cardiodiabetes for given analytes are defined as optimal (low risk), intermediate (elevated risk), and high risk. In some cases risk level will be assigned in conjunction with a group of analytes of 2 or more in the form or a ratio or index score. In some cases an overall risk level will be assigned based on relative risks of individual scores or analytes in related groups.

In another embodiment of the invention, the quantitative measurements of the biomarkers can be transformed collectively by a mathematical operation using the processor to generate a cardiodiabetes index score. The cardiodiabetes categorical risk level can then be assigned in conjunction with the generated cardiodiabetes index score by the processor. The generated cardiodiabetes index score is compared with a reference value range.

In addition, the cardiodiabetes categorical risk level and cardiodiabetes index score can be further evaluated against one or more clinical endpoint components of the cardiodiabetic disease. The evaluated cardiodiabetes categorical risk level and generated cardiodiabetes index score can be included in the patient-specific cardiodiabetes health report by the processor.

As used herein, the term “clinical endpoint” generally refers to occurrence of a disease, symptom, sign or laboratory abnormality that constitutes one of the target outcomes of the diagnostic test results.

These one or more clinical endpoint components of cardiodiabetic disease include e.g., measurements of blood glucose level at any time point in an OGTT or mixed meal challenge, measurements of blood insulin level at any time during an OGTT or mixed meal challenge, early signs of impaired first and/or second phase insulin secretion, early signs of impaired incretin response, early signs of impaired glucose disposal rate, early signs of adipose insulin resistance, early signs of hepatic insulin resistance, early signs of microvascular cardiodiabetic disease, and early signs of macrovascular cardiovascular disease.

Systems for performing the methods described herein are also included, as are systems for generating the patient-specific cardiodiabetes health reports that is relevant to assess the patient's cardiodiabetes risk.

Prior their delivery and accessibility to the physician, health care provider or patient, the patient-specific cardiodiabetes health reports may be printed, faxed, in paper ((“real”) or electronic (“virtual”) format viewable on a PC or handheld device such as a cell phone. The cardiodiabetes health reports can be secured so that they can be accessed only by a physician and/or in some variations the patient. The cardiodiabetes health reports may contain transformed data, or graphics formatted in the manner according to the methods described by Warnick, Caffrey and Hoefner in U.S. Provisional Patent Applications, 61/684,056, filed Aug. 16, 2012 and 61/778,595, filed Mar. 13, 2013, respectively and both patent applications are entitled “Method of Data Transformation and Presentation for Panels of Grouped Diagnostic Analytes.”

A biological sample from a patient is contacted. The biological sample is assayed by means of diagnostic tests familiar to those in the art, and analytes in the biological sample are measured. In some cases ratios or indices are calculated based on these measured values. Measured values and indices are compared to known reference ranges that are either standard in industry or empirically determined by clinical study within HDL. Risk levels of optimal, intermediate or high are assigned based on the comparison of the measured or calculated values to the standard reference range.

The values of the analytes and scores and their associated risk levels are arranged on a report for viewing by a healthcare provider or patient. There are five groupings of related analytes on the report related to risk of development of cardiodiabetes, and complications and adverse events arising therefrom. The five groups are: 1) Total Glycemic Control, 2) Beta Cell Function, 3) Insulin Resistance, 4) Inflammation, and 5) Dyslipidemia. The summation of values and associated risk in each sub-group, displaying different but related information in a concise and intuitive way for healthcare provider comprehension, facilitates more rapid and accurate assessment of diagnosis, prognosis, choice of therapy, and (with repeated measurements of the panels), monitoring of response to therapy.

Because healthcare providers are presented with more comprehensive testing panels than currently available, with unique analytes and combinations of analytes, they are able to act on this more complete data set by treating patients with the most appropriate therapies at an earlier time, and transform the state of the patients' health, particularly in regards to minimizing the patients' risk of cardiovascular disease that may arise from cardiodiabetes. Therapies are defined as drug therapies, nutritional supplements, surgical intervention, and advising the patient to make lifestyle changes such as diet, exercise, weight loss, and improvement of dental hygiene; therapy can also constitute a program of “active surveillance” and repeat monitoring of patient progress.

Some biomarkers and analytes are “core” analytes and integral to each panel. Others are optional and may or may not be added to the core claimed analytes for each panel. These are described in detail in the section following the signature page.

Software programs for data interpretation, risk assignment, and therapy guidance related to contacting samples from a patient and measuring levels of analytes and associated risk levels on one or more panels, are also claimed as an embodiment of this invention.

Some scores or ratios claimed in panels such as c-peptide/insulin, proinsulin/insulin, and c-pep+proinsulin/insulin may be calculated but omitted from the report if the values are not abnormal. Alternatively, they may be reported in the body of the report along with the amounts of analytes themselves (when measured and reported), or mentioned as a “comment” in the “notes” section at the end of the report.

For Glycemic Control Panel, the addition of [D-mannose] (aka fasting plasma mannose, FPM) to the core biomarker panel measurements of glucose, HbA1c, fructosamine, and glycation gap in an inclusive panel is novel. The addition of plasma 1,5 A-G to the Glycemic control panel is also novel (I do not believe this has been claimed in conjunction with the glycation gap, but it has definitely not been claimed in conjunction with measurement of the analytes above plus D-mannose concentration. The addition of one or more of the following to the core panel described in Table 1, column 2, “optional accessory” is also novel.

For Beta Cell Function Panel, the core claimed tests are serum amylase, anti-GAD antibody, c-peptide, intact pro-insulin. In addition to the core Beta Cell Function panel, measuring at least one of the biomarkers comprised from the list of optional/accessory biomarkers in Table 1 column 2, confers further novelty. Inclusion of the optional CLIX score in the beta cell function panel is novel because the score (which incorporates in its calculation time-course measurements of serum creatinine, glucose and C-peptide) is a useful proxy for insulin secretion/pancreatic function in Type-1 diabetics who take exogenous insulin as well as in IR/T2DM patients; additionally detection of auto-antibodies known to be responsible for development of Type 1 diabetes, and low levels of serum amylase also allow Type 1 diabetics to be distinguished from Type 2 and insulin resistant patients. Further novelty arises because the CLIX score is better able to distinguish early stages of insulin resistance than the HI clamp technique with better reproducibility, and in combination with the other biomarkers on the panel distinguishes between Type 1 and Type 2 diabetes pancreatic dysfunction. The CLIX score also allows for diagnosis of improvement or deterioration in pancreatic function, particularly in Type 1 diabetics who are taking exogenous insulin therapy, via its measurement of baseline C-pep in conjunction with the serial measurements of C-pep (a proxy for insulin secretion) taken during the CLIX. Other novel aspects of this test panel arise from inclusion of the additional analytes fasting C-peptide (which is cleaved to pro-insulin), intact pro-insulin (which is cleaved to insulin), and insulin itself. The chief advantage of this particular panel of biomarkers for Beta Cell Dysfunction compared to standard panels commonly sold (such as combinations of insulin, pro-insulin, and c-peptide in conjunction with fasting plasma glucose), is that this panel not only distinguishes between Type 1 and Type 2 diabetics, it can also measure deterioration or improvement in pancreatic beta cell function in both type 1 and type 2 diabetics, and the panel can also detect the very early stages of insulin resistance/metabolic syndrome. There is no other diagnostic panel for cardiodiabetes/insulin resistance including these biomarkers in this specific combination for this purpose and thus the combination is novel and patentable.

For the Insulin Resistance Panel, the core biomarker panel includes FPM, leptin, adiponectin, ferritin, and Free Fatty Acids (FFA). Additionally, the measurement of at least 1, at least 2, etc. biomarkers from the list comprising: alpha hydroxybutyrate, Oleic Acid, L-GPC, IR Score (Metabolon), HOMA IR Score, CLIX, OGTT, fasting plasma glucose, acylcarnitines, and the ratio of mannose/glucose at any timepoint during an OGTT.

For Inflammation Panel, the core analytes include LpPLA₂, fibrinogen, hsCRP, F2-isoprostanes, and Myeloperoxidase (MPO), in addition to at least 1 of the following analytes from the list comprising: fibrinogen degredation products (FDP), D-dimer, oxidized phospholipids, oxidized lipoproteins, HSP 60, HSP 70, Cytokines and acute-phase reactants such as IL-6, MCP-1, TNF-α, IL-18, IL-10, and serum amyloid A (SAA); soluble endothelial adhesion molecules such as ICAM (intercellular adhesion molecule), VCAM (vascular cell adhesion molecule), E-selectin; von Willebrand factor (vWF), secretory phospholipase A2 (sPLA2), Vascular endothelial growth factor (VEGF), placental growth factor (P1GF), hepatocyte growth factor (HGF), and matrix metalloproteinases (MMPs), including MMP-1, -2, and -9, as well as pregnancy-associated plasma peptide A (PAPP-A); also platelet count, and clotting times.

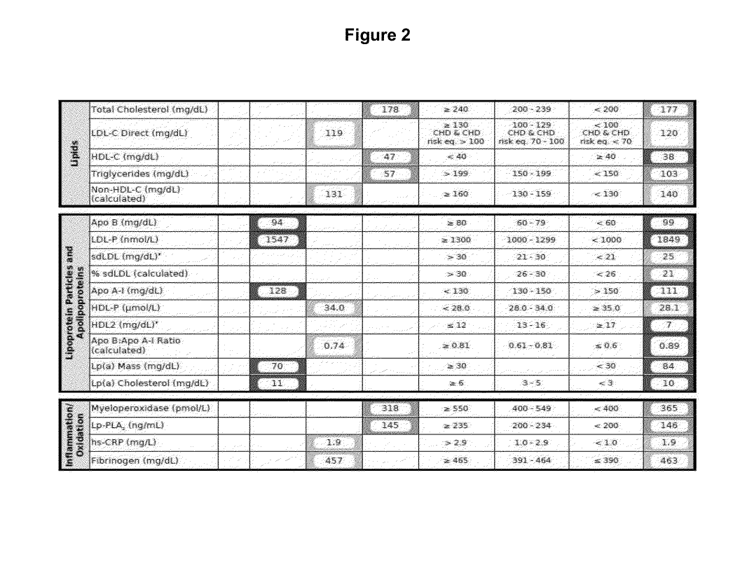

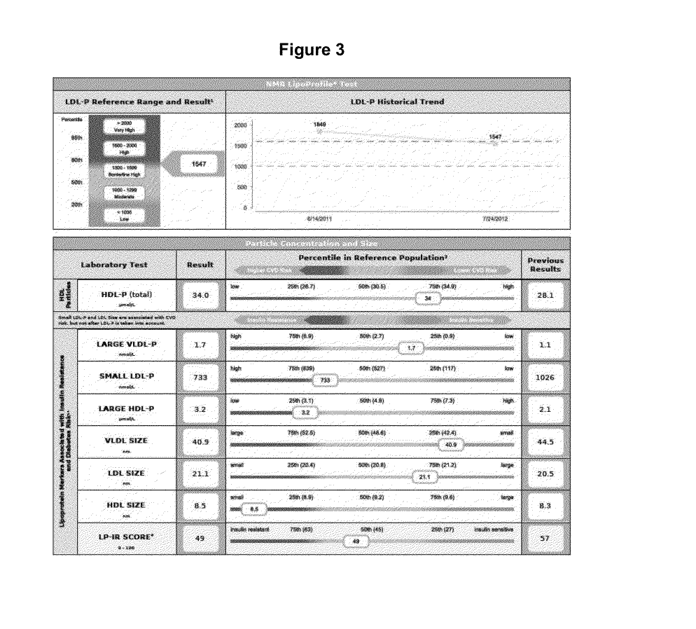

For Dyslipidemia, the core analytes include all lipids and lipoproteins in FIG. 2, and Lipoprotein Remnants, as the core biomarker panel. The addition of Lipoprotein Remnants (which are primarily derived from IDL and VLDL) to the panel in Table 2 confers novelty as it is not currently commercially offered with this specific panel of tests. In addition to the core panel previously mentioned, at least one, at least 2, at least 3, at least 4, at least 5, at least 6, at least 7, or at least 8, of the additional measurements in FIG. 3 are also included. The use of one or more of the following: the measurement of cholesterol and triglycerides contained within one or more specific subtypes of lipoprotein particles, namely LDL1, LDL2, LDL3, LDL4, IDL, VLDL1, VLDL2, VLDL3, remnant lipoprotein; and LDL density patterns, HDL density patterns, oxidized LDL, oxidized HDL, oxidized ApoA-1, oxidized ApoB, ApoB-48, ApoC-1, ApoC-2, ApoC-3, ApoE, ApoE genotype, HDL particles with integrated SAA, HDL particles with integrated ApoC-1, HDL particles with bound endotoxin, HDL electronegativity, LDL electroengativity, IDL electronegativity, HDL particle stability, LDL particle stability, IDL particle stability, VLDL particle stability, and absolute amount of Mannose Binding Protein (MBP) (aka Mannose Binding Lectin, MBL), biological activity of MBL, and associated genetic polymorphisms and known haplotypes thereof are also included.

Additional novelty beyond the combination of analytes in individual panels is the additive benefit of combining the information from the Glycemic Control, Beta Cell Function, Insulin Resistance, Inflammation and Dyslipidemia panels into a more complete analysis of the biology and physiology underlying the process of disease development and progression and response to treatment in a given individual who is tested once, or repeatedly. Each panel can be used as a novel diagnostic panel alone, in and of itself, to give useful information to a healthcare provider that will improve clinical decision-making and optimize therapy guidance and minimize patient risk of cardiodiabetes and its complications. Since each panel is novel in and of itself, the use of can be accomplished by any one panel alone, or in combination with at least 1 other panel, at least 2 other panels, at least 3 other panels, or at least 4 other panels (i.e. all five panels together).

### Example 1

### Statistical Methods for Clustering Analysis in Tables 2-7 and Corresponding Heat Maps

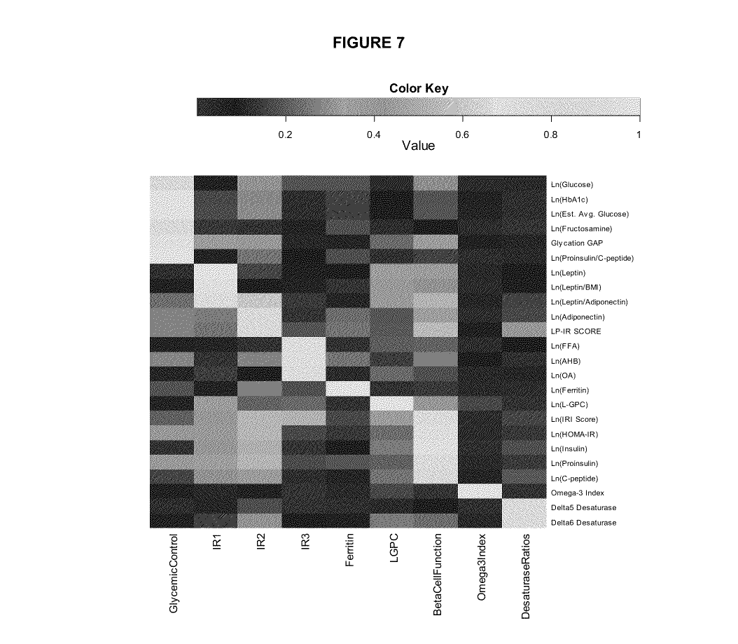

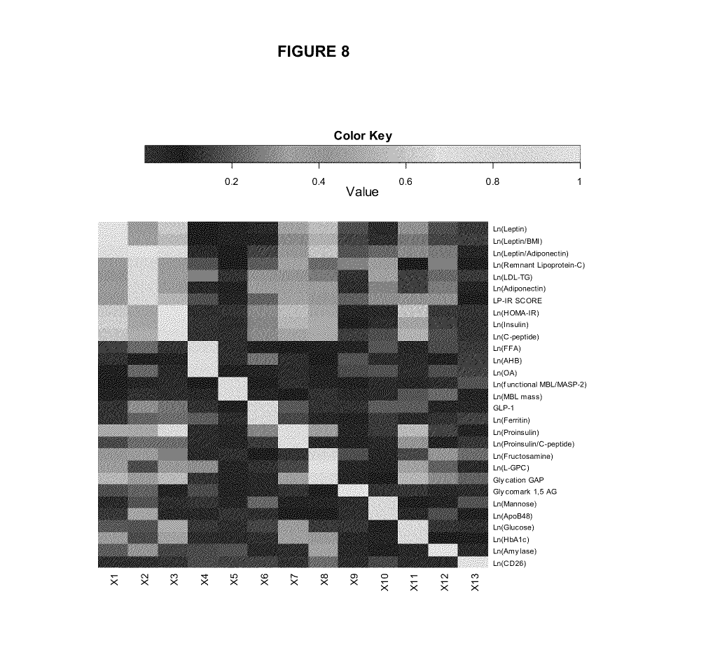

Each disjoint cluster, labeled X1-X-7 or X1-X13, includes a cluster component score based on a linear combination of the weighted, standardized biomarker values contained within that cluster. The linear combinations were obtained using principal components (PC) analysis to maximize the amount of explained variability; however, the PC are rotated (i.e. not orthogonal) hence the disjoint clusters are correlated. PC identifies groups of well-correlated biomarkers (that share an unobserved dimension in the data). The natural log was taken to make the biomarkers more symmetric and thus reduce the influence of outliers in the dataset. Inherent in the PC analysis are methods to optimize explained variability, which is the variability that is not random. PC explains total variability which includes common (shared) variability among the markers, and random error. The number of clusters was determined by considering: eigenvalues, minimum R-squared value between a biomarker and its cluster component score, total variability explained in the data, and subject matter knowledge. The clusters biomarkers membership and the amount of variation explained in each biomarker by its own cluster are given in Table 2 (7 cluster model) and Table 5 (13 cluster model). By adding ten additional biomarkers to the dataset that generated the 7 cluster model and following the same procedure, seven of the ten new biomarkers created 5 new clusters representing additional axes of information. A heat map was used to show the absolute value of the correlation between the values of each biomarker and each cluster component score (FIGS. 7 and 8). The clusters form blocks of high correlation values, which can be seen on the main diagonal of the heat map. This indicates those variables that are homogeneous (shown in yellow and light tan color). Whereas blue and purple colors indicate independence between clusters and biomarkers; green represents moderate correlations. To relate the inclusion of biomarkers from groups claimed in this application to improvement of an index risk score, analysis in Table 6 was performed. The area under the OGTT curve for FFA times C-peptide, and 1-hr, and 2-hr glucose responses were modeled as the dependent variables to determine which biomarkers are related to these endpoints; this analysis is a non-limiting example of how meaning is provided and assigned to the clusters.

TABLE 2
Cluster Summary for 7 Clusters (N =
1479, DPMP study; Study #2)

| | | Variation | Proportion | Second |
|---|---|---|---|---|
| Cluster | Members | Explained | Explained | Eigenvalue |
| Glycemic Control | 6 | 4.075104 | 0.6792 | 0.9600 |
| IR-1 | 3 | 2.75648 | 0.9188 | 0.2298 |
| IR-2 | 2 | 1.604829 | 0.8024 | 0.3952 |
| IR-3 | 3 | 2.25615 | 0.7520 | 0.6450 |
| IR-4 (Ferritin) | 1 | 1 | 1.0000 | |
| IR-5 (L-GPC) | 1 | 1 | 1.0000 | |
| Beta Cell Function | 5 | 4.075742 | 0.8151 | 0.4034 |
| Omega-3 Index | 1 | 1 | 1.0000 | |
| Fatty Acid | 2 | 1.629266 | 0.8146 | 0.3707 |
| Desaturase Ratios | | | | |

Total variation explained = 19.39757 Proportion = 0.8082

TABLE 3
Biomarker Summary for 7 clusters (N = 1479, DPMP Study; Study #2)
Proportion of explained variability in each biomarker by its
cluster component score (first column, explained variability with
own cluster, R-squared

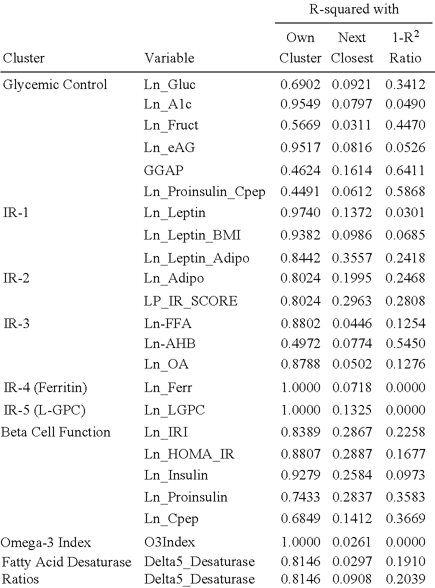

The OGTT Index components are highlighted in yellow.

TABLE 4
Inter-Cluster Correlations for 7 cluster model; Study #2

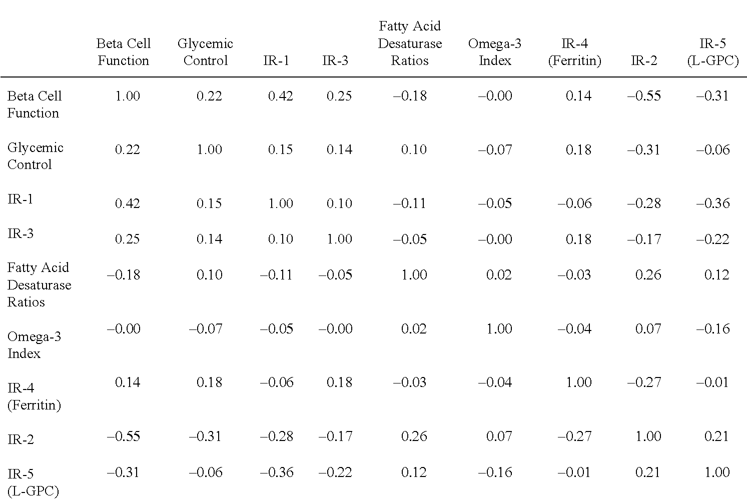

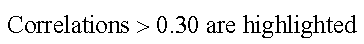

TABLE 5
Cluster summary for 13 clusters (N = 162); Study #1

| | | Cluster | Variation | Proportion | Second |
|---|---|---|---|---|---|
| Cluster | Members | Variation | Explained | Explained | Eigenvalue |
| 1 | 3 | 3 | 2.814973 | 0.9383 | 0.1744 |
| 2 | 4 | 4 | 2.917765 | 0.7294 | 0.4742 |
| 3 | 3 | 3 | 2.846232 | 0.9487 | 0.1397 |
| 4 | 3 | 3 | 2.17735 | 0.7258 | 0.6496 |
| 5 | 2 | 2 | 1.72955 | 0.8648 | 0.2704 |
| 6 | 2 | 2 | 1.312203 | 0.6561 | 0.6878 |
| 7 | 2 | 2 | 1.76549 | 0.8827 | 0.2345 |
| 8 | 3 | 3 | 1.992144 | 0.6640 | 0.7319 |
| 9 | 1 | 1 | 1 | 1.0000 | |
| 10 | 2 | 2 | 1.302942 | 0.6515 | 0.6971 |
| 11 | 2 | 2 | 1.586604 | 0.7933 | 0.4134 |
| 12 | 1 | 1 | 1 | 1.0000 | |
| 13 | 1 | 1 | 1 | 1.0000 | |

Total variation explained = 23.44525
Proportion = 0.8085

TABLE 6
Biomarker summary for 13 clusters (N = 162);
Study #1. Proportion of explained
variability in each biomarker by its cluster
component score (first column,
explained variability with own cluster, R-squared

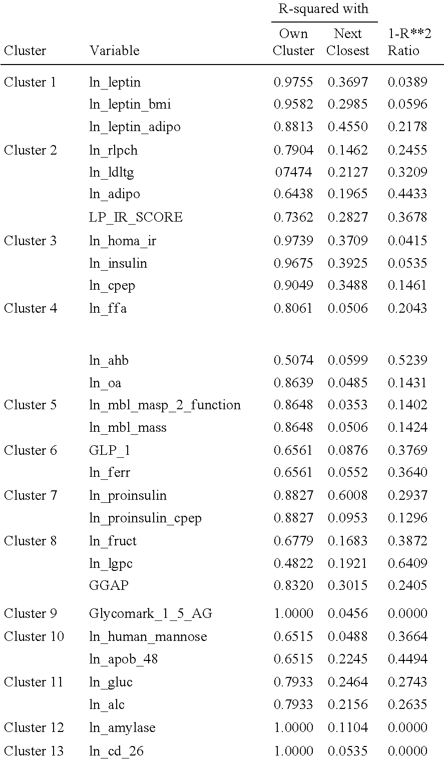

• Newly added 10 biomarkers (beyond 7 cluster model) highlighted in yellow

TABLE 7
Comparison of sets of biomarkers and OGTT endpoints (N = 188); Study #1
Statistical Methods:

| | Endpoints | | | | |
|---|---|---|---|---|---|
| | Ln(C-peptide AUC * | 1-hr Glucose | 2-hr Glucose | 1-hr Glucose | 2-hr Glucose |
| | FFA AUC) | Continuous | Continuous | ≧155 mg/dL | ≧140 mg/dL |
| OGTT Index | X | X | X | X | X |
| Ln(functional | X | | | | |
| MBL/MASP-2) | | | | | |
| Ln(MBL mass) | X | X | X | X | X |
| Ln(Amylase) | X | | | | |
| GLP-1 | | | | | |
| Ln(Mannose) | | | | | |
| 1,5 AG | | X | X | X | X |
| Ln(LDL-TG) | | | | | |
| Ln(Remnant | | | | | |
| Lipoprotein-C) | | | | | |
| Ln(ApoB48) | | | | | |
| Ln(CD26) | | | | | |

X = indicates a variable was selected in at least 500 of the 1000 bootstrapped samples.

The OGTT Index was calculated for all subjects, and then it plus the 10 additional biomarkers listed in Table 2 were eligible to be selected as predictor variables in linear models for the dependent responses (i.e. endpoints). To improve generalization of the results, 1000 bootstrapped samples were created and predictor variables were selected if they were included in the final model that minimized Akaike's information criterion (AIC) in at least 500 of the samples.

Results: Mannose Binding Lectin (MBL) mass and 1,5 AG independently improved prediction of the OGTT endpoints. Functional MBL/MASP-2 was also selected in over 50% of the models for the product of C-peptide AUC and FFA AUC; it is shown in the same dimension as MBL mass (Table 1). Amylase was also selected, which is its own dimension of information.

### Clinical Study Protocols

### Study #1

All laboratory measurements were performed at Health Diagnostic Laboratory, Inc. (HDL).

Glucose tolerance testing was performed according to standardized protocol. Fasting blood samples were collected before administration of glucola (75 mg glucose solution), which was consumed within 5 minutes. Additional blood samples were collected at either (1) 30, 60, 90, and 120 minutes, or at (2) 60 and 120 minutes, from completion of the glucola. All patients avoided eating, drinking, or smoking during the testing period.

Study #1 Subjects: 217 consecutive nondiabetic subjects underwent a 75 g oral glucose tolerance test (OGTT) and fasting blood collection to evaluate risk of diabetes between March 2012 and May 2013 at several outpatient centers across the US (Madison, Wis.; Jackson, Miss.; Montgomery, Ala.; Charleston, S.C.; Seattle, Wash.; and Salt Lake City, Utah). Clinical indications for testing included obesity, history of first-degree family members with diabetes, and presence of one or more components of the metabolic syndrome, including impaired fasting glucose. Samples were sent by overnight courier to Health Diagnostic Laboratory, Inc. (Richmond, Va.) for measurement of glucose, insulin, metabolites, and other biomarkers. Subjects with detectable anti-GAD antibody (titer >5 IU/ml) were excluded from this study regardless of T1DM or LADA status. The study protocol was approved by Copernicus Group IRB (NC). All analyses involved de-identified data only and were covered by a waiver of consent and authorization requirements. Insulin resistance (IR) was defined by one or more of the following conditions: fasting glucose ≧100 mg/dL, 2-hour glucose ≧140 mg/dL, HbA1c≧5.7%, fasting insulin ≧12 μU/mL. Transient hyperglycemia (TH) was defined as 30, 60, or 90-minute glucose ≧140 mg/dL during OGTT.

Statistical Methods Study #1: General linear mixed models were used with restricted maximum likelihood (REML) estimation to analyze the mean response profiles for insulin and glucose changes over the 3- or 5-time point 2-hour OGTT. A cubic regression model was fit to the data since the curve's characteristics were known to include two inflection points. The unstructured repeated measures covariance matrix was chosen since it minimized Akaike's Information Criterion (AIC). (Akaike H. Information theory and an extension of maximum likelihood principal. 2nd International Symposium of Information Theory and Control 1973:267-281) The insulin response was transformed using the natural transformation to improve the normality and homoscedasticity of the residual errors. To determine if α-HB modified the insulin or glucose response, interactions were tested between tertiles of AHB with time, time, and time using F-tests and Wald tests. Interactions were also tested between BMI categories (i.e. normal <25, 25≦overweight <30, and obese ≧30 kg/m2) and the cubic time response.

Next, multivariable logistic regression was used to test the association (i.e. odds ratio) and incremental improvement in discrimination (i.e. c-statistic) of subjects with 1-hour glucose ≧155 mg/dL when α-HB was added to age, gender, BMI, fasting glucose, Ln(fasting insulin), Ln(triglycerides), HDL-C, and LDL-C. Fasting insulin and triglycerides were natural logarithm transformed to reduce leverage of extreme observations. When testing the usefulness of a novel biomarker, the American Heart Association recommends reporting the marker's statistical association, discrimination, calibration, and reclassification performance (Hlatky M A, Greenland P, Arnett D K, Ballantyne C M, et al. Criteria for evaluation of novel markers of cardiovascular risk: A scientific statement from the American Heart Association. Circulation 2009; 119:2408-2416). Hosmer-Lemeshow was used as a measure of model calibration Hosmer D W, Hosmer T, Le Cessie S, Lemeshow S. A comparison of goodness-of-fit tests for the logistic regression model. Stat. Med 1997; 16:965-980). The reclassification was tested when α-HB was added to the fully adjusted logistic regression model with the integrated discrimination improvement (IDI) metric, which can be described as the average increase in sensitivity given no change in specificity. The percentage of subjects who had model probabilities changed in the correct direction (i.e., increased for those with events and decreased for non-events) due to the addition of α-HB to the fully adjusted model was tested with the continuous net reclassification index (NRI). SAS® version 9.3 (Cary, N.C.) was used for all analyses, with the critical level set to 0.05 to prescribe statistical significance.

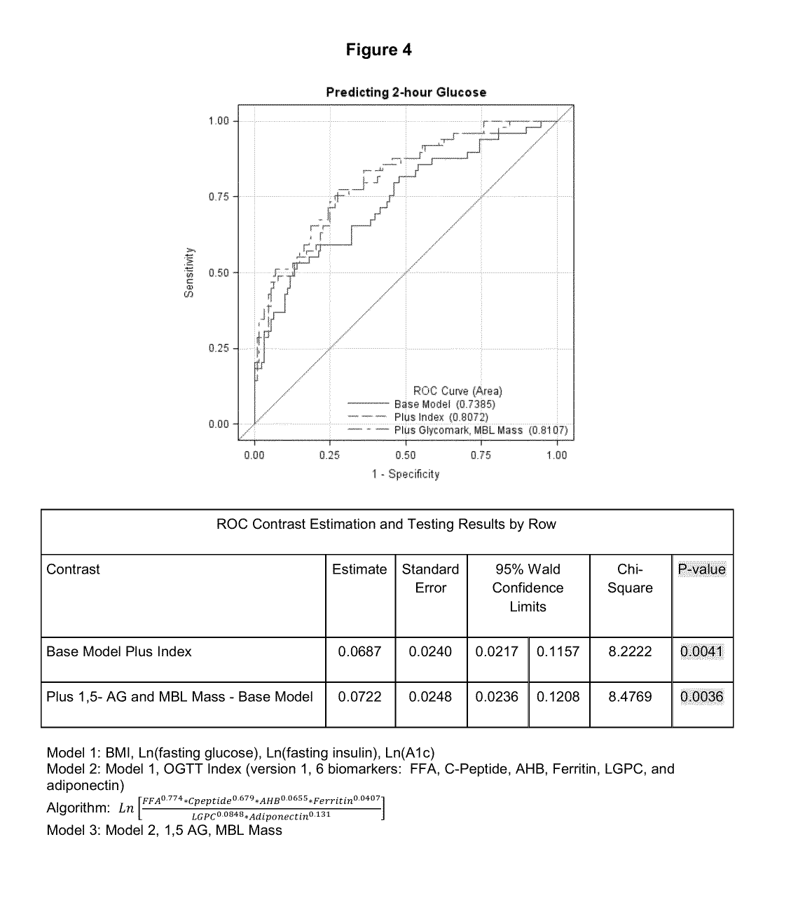

Results from study #1 generated via the statistical methods above were then analyzed for the utility of all biomarkers measured and enumerated in this patent application to determine the utility of the biomarkers in identification and classification of patients who were at risk of cardiodiabetes. ROC curves (FIGS. 4-6) for various combinations of biomarkers enumerated in this patent application were generated in order to illustrate how the AUC for prediction of various clinical endpoints was improved by combinations of biomarkers from the claimed categories. Furthermore, Principal Component Analysis (PC) followed by clustering as described in the “Statistical Methods” section of this application were used to identify biomarkers included in our claimed analytes that add specific and unique information when used in combination (Tables 5-7 and FIG. 8 (heatmap 2)). The analysis presented here is for a 13 cluster analysis, and this intended as a non-limiting example and does not necessarily exemplify the preferred embodiments of the claims herein.

It should be noted that not all data analyses contain data from the total number of study subjects (217). This is because not all tests were run on all samples due to factors beyond the control of HDL, such as insufficient sample volume to perform specialty tests or errors in collection procedure. Throughout this application the exact number of patients included in each statistical analysis have been noted.

### Study #2 (DPMP Study)

### General Study Design, Study #2

This was a retrospective cohort study investigating fasting biomarker profiles of 1,687 consecutive patients receiving treatment between Apr. 1, 2012-May 27, 2013 at one of several outpatient centers across the U.S. (Madison, Wis.; Jackson, Miss.; Montgomery, Ala.; Charleston, S.C.; Seattle, Wash.; and Salt Lake City, Utah). Select family and medical history, current medication status, vitals, and demographic information was collected retrospectively from chart review and matched to laboratory data before being completely de-identified. No inclusion or exclusion criteria beyond availability of matched datasets were used. The study protocol was approved and a waiver of informed consent and Health Insurance Portability and Accountability Act (HIPAA) authorization requirements was granted by Copernicus Group IRB (Durham, N.C.). Patient data collected from the University of Utah was also covered under a waiver of consent requirements provided by the University of Utah IRB.

### Laboratory Measurements, Study #2

Comprehensive biomarker testing included a total of 21 blood-based biomarkers, organized into 5 different categories: 1. Glycemic control; 2. Insulin resistance and 3. Pancreatic beta cell function 4. Lipids and lipoproteins. 5. Biomarkers of Inflammation. All samples were analyzed at HDL in Richmond, Va.

### Statistical Analysis

Statistical analysis was performed with methods as described in study #1. All statistical tests were performed with either StatView version 5 or SAS software (version 9.3; SAS Institute). Statistical significance was defined as p<0.05. As with Study #1 above, the results generated via the described statistical methods were further analyzed for the utility of all biomarkers measured and enumerated in this patent application to identify and classify patients who were at risk of cardiodiabetes. Principal Component Analysis (PC) followed by clustering as described in the “Statistical Methods” section of this application were again used to identify biomarkers included in our claimed analytes that add specific and unique information when used in combination (Tables 2-4 and FIG. 7 (heatmap 1)). The analysis presented here is for a 7 cluster analysis, and this also is intended as a non-limiting example and does not necessarily exemplify the preferred embodiments of the claims herein.

FIGS. 7 and 8 show heat maps of the absolute value of the Pearson's correlation between the values of each biomarker and each cluster component score (7 and 13 clusters, respectively). As shown in FIG. 8, the clusters form blocks of high correlation values, which can be seen on the main diagonal of the heat map. This indicates those variables that are homogeneous (shown in yellow and light tan color), whereas blue and purple colors indicate independence between clusters and biomarkers; green represents moderate correlations.

Study #1. Improvement in Predicting 2-Hr Glucose as Clinical Endpoint. Base model is BMI, Ln(fasting glucose), Ln(fasting insulin), Ln(A1c). Index Score comprises a set of 6 biomarkers from claimed panels, specifically 1) Lipids (FFA and L-GPC) 2) beta cell function (C-peptide and AHB), and insulin resistance—(hepatic-ferritin and adipose-adiponectin). In study #2 this algorithm was able to predict which apparently normo-glycemic individuals would have an abnormal blood glucose value at 2 hours on OGTT with net reclassification of 63% (44% of patients were reclassified from NGT to IGT and 19% were reclassified from IGT to NGT). This algorithm therefore allowed for re-assessment of risk of cardiodiabetes (based on clinical endpoint of abnormal 2-hr OGTT), such that a portion of patients were raised from optimal/low risk into an intermediate or high risk category, and a portion of patients were lowered from an intermediate or high risk category to a low/optimal risk category. In the ROC curve below, it can be seen that combining this risk index algorithm with the base model gives a significant improvement in predictive power, and the addition of 2 other biomarkers to the model (Glycemic Control Group—1,5 AG and Inflammation—MBL Mass) further improve the predictive power. The combinations of analytes from different contributing pathways to cardiodiabetes risk, when combined, enable more accurate assessment and assignment of cardiodiabetes risk to patients without having to undergo an OGTT. See FIG. 4 for illustration.

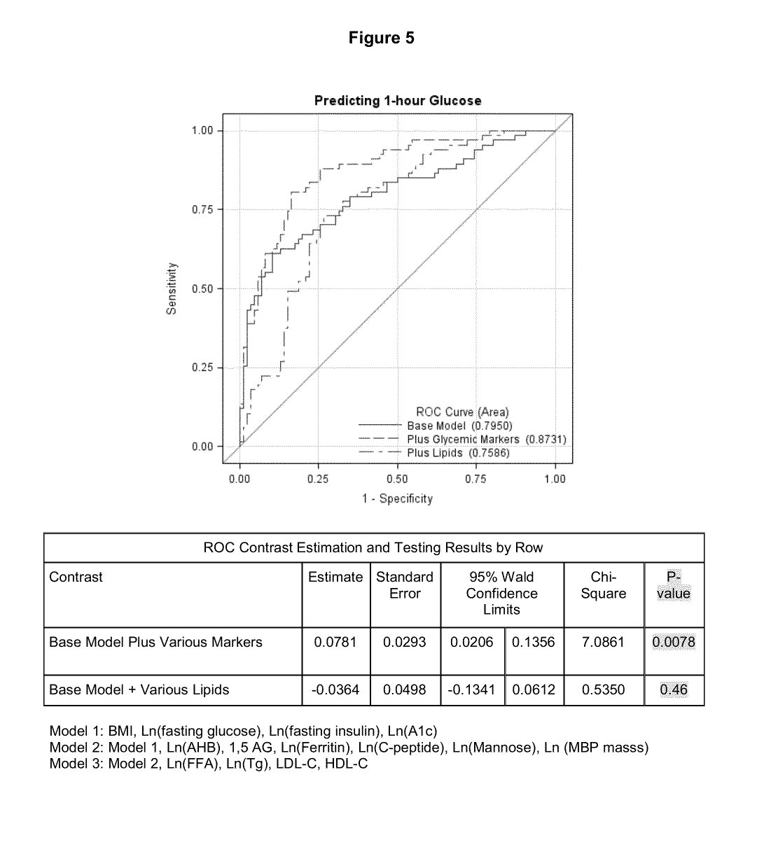

Study #1. Predictive Improvement in 1-hour Glucose Clinical Endpoint by addition of claimed biomarkers. In this model the addition of biomarkers comprising the groups beta cell function (AHB and c-peptide), Glycemic Control (1,5 AG, mannose) Insulin Resistance (Ferritin and MBL mass), combined to significantly improve predictive power for 1 hour glucose, and enable categorization of patients' cardiodiabetes risk category from a baseline sample, without undergoing an OGTT. In this study lipids did not improve the risk assessment. See FIG. 5 for illustration.

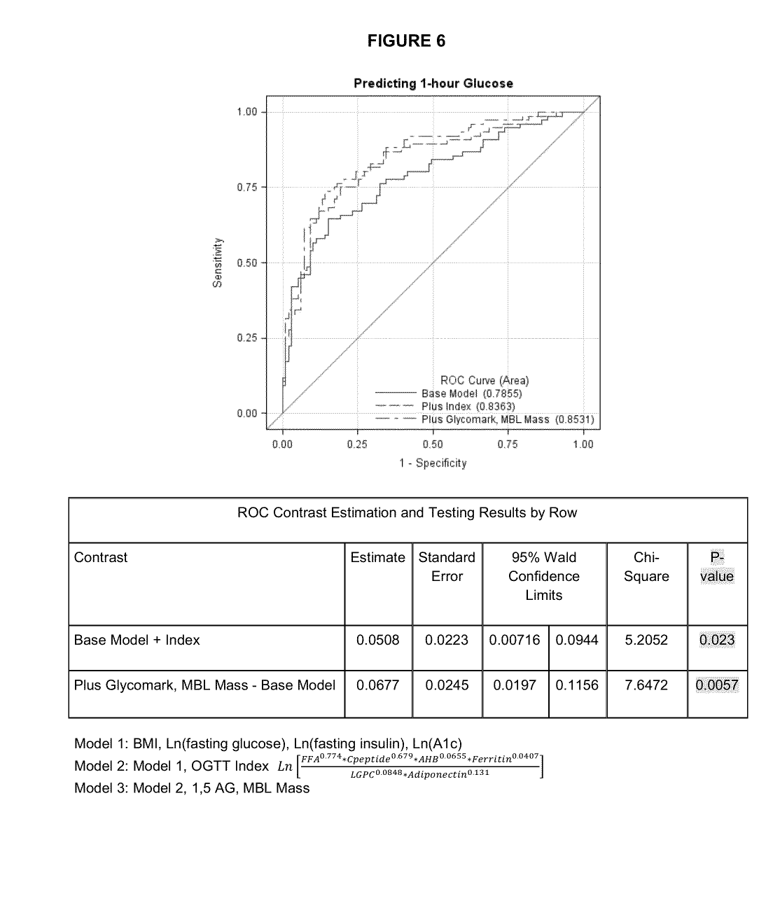

Study #1. Improvement in Predicting 1-Hr Glucose as Clinical Endpoint. N=175. Base model is BMI, Ln(fasting glucose), Ln(fasting insulin), Ln(A1c). Index Score comprises a set of 6 biomarkers from claimed panels, specifically 1) Lipids (FFA and L-GPC) 2) beta cell function (C-peptide and AHB), and insulin resistance—(hepatic-ferritin and adipose-adiponectin). Combining this risk index algorithm with the base model gives a significant improvement in predictive power, and the addition of 2 other biomarkers to the model (Glycemic Control Group—1,5 AG and Inflammation—MBL Mass) further improve the predictive power. The combinations of analytes from different contributing pathways to cardiodiabetes risk, when combined, enable more accurate assessment and assignment of cardiodiabetes risk to patients without having to undergo an OGTT. See FIG. 6 for illustration.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

### REFERENCES

Sone, et al., Physiological changes in circulating mannose levels in normal, glucose-intolerant, and diabetic subjects, Metabolism 52(8):1019-27, 2003
Anderwald, et. al., The Clamp-Like Index: a novel and highly sensitive insulin sensitivity index to calculate hyperinsulinemic clamp glucose infusion rates from oral glucose tolerance tests in nondiabetic subjects, Diabetes Care, 30(9):2374-2380, 2007.
Pitkänen, O. M. et al, Metabolic syndrome is associated with changes in D-mannose metabolism. Scand. J. Clin. Lab. Invest., 59(8):607-612, 1999.
Megia, et al., Mannose binding lectin gene polymorphisms are Associated with Gestational Diabetes Mellitus, J. Clin. Endo. Metab., 89(10):5081-5087, 2004.
Yamanouchi, et al., Common reabsorption system of 1,5 anhydro-D-glucitol, fructose and mannose in rat tubules, Biochim. Biophys. Acta, 1291(1):89-95, 1996.
Ganda, O. P. et al., Metabolic effects of glucose, mannose, galactose, and fructose in man, J. Clin. Endocrinol. Metab., 49(4):616-22, 1979.
Madsen, H. O. et al., Association of mannose-binding lectin deficiency with severe atherosclerosis, Lancet, 352:959-60, 1998.
Hegele, R. et al., Mannose-binding lectin gene variation and cardiovascular disease in Canadian Inuit, Clin. Chem. 45(8):1283-1285, 1999.
Madsen, H. O. et al., Interplay between promoter and structural gene variants control basal serum level of mannan-binding protein, J. Immunol., 155:3013-3020, 1995.
Salimans, et al., Association between familial deficiency of mannose-binding lectin and mutations in the corresponding gene and promoter region, Clin. Diagn. Lab. Immunol., 11(4):806-807, 2004.
Kuipers, et al., A hemolytic assay for the estimation of functional mannose binding lectin (MBL) levels in human serum, J. Immunol. Methods, 268:149-157, 2002.
Petersen, K. A. et al., Phase I safety, tolerability, pharmacokinetic study of recombinant human mannan-binding lectin, J. Clin. Immunol. 26:465-75, 2006.
Xia, et. al., Lipid accumulation product is a powerful index for recognizing insulin resistance in non-diabetic individuals, Eur. J. Clin. Nutr., 66(9):1035-1038, 2012.
Gordon, A. H. and Koy, A., The acute phase response to injury and infection. The Roles of Interleukin 1 and Other Mediators, Amsterdam, Elsevier, 1985.
Gabay, C. et. al., Acute-phase proteins and other systemic responses to inflammation, N. Engl. J. Med., 340(6):448-454, 1999. Erratum in N. Engl. J. Med., 340(17):1376, 1999.
Mackiewicz, A. et al., Effects of cytokine combinations on acute phase protein production in two human hepatoma cell lines. J. Immunol., 146(9):3032-3037, 1991.
Zairis, M. N. et al., Serologic markers of persistent chlamydia pneumonia infection and long-term prognosis after successful coronary stenting, Am. Heart J., 146(6):1082-1089, 2003.
Malave, H. et al., Evaluation of low-density lipoprotein particle number distribution in patients with type 2 diabetes mellitus with low-density lipoprotein cholesterol <50 mg/dl and non-high-density lipoprotein cholesterol <80 mg/di, Am. J. Cardiol., 110(5):662-665, 2012.
Kontush, A. and Chapmman, M. J., Functionally defective high-density lipoprotein: a new therapeutic target at the crossroads of dyslipidemia, inflammation, and atherosclerosis, Pharmacol. Rev., 58(3):342-374, 2006.
Nakajima, K. et al., The oxidative modification hypothesis of atherosclerosis: the comparison of atherogenic effects on oxidized LDL and remnant lipoproteins in plasma. Clin. Chim. Acta, 367 (1-2):36-47, 2006.
Qing, X. et al., Cystatin C and asymptomatic coronary artery disease in patients with metabolic syndrome and normal glomerular filtration rate, Cardiovasc. Diabetol., 11:108, 2012.
Vengen, I. T. et al., (2012) Mannose-binding lectin deficiency is associated with myocardial infarction: the HUNT2 study in Norway, PLoS ONE, 7(7):e42113, 2012.
Chalmers, J. D. et al., Impact of mannose-binding lectin insufficiency on the course of cystic fibrosis: a review and meta-analysis, Glycobiology, 21(3):271-282, 2011.
Wallis, R. and Lynch, N. J., Biochemistry and genetics of the collectins. In: Kilpatrick, D. (ed), Collagen-Related Lectins in Innate Immunity, Trivandrum: Research Signpost, pp. 33-56, 2007.
Swierzko, A. S. et al., Mannan-binding lectin genotypes and genotype-phenotype relationships in a large cohort study of Polish neonates. Hum. Immunol, 70(1):68-72, 2009.
Nakajima, K. et al., Low serum amylase in association with metabolic syndrome and diabetes: a community-based study, Cardiovasc. Diabetol., 10:34, 2011 (a)
Nakajima, K. et al., Revisiting the cardiometabolic relevance of serum amylase. BMC Res. Notes, 4:419, 2011 (b)
Muneyuki, T. et al., Latent associations of low serum amylase with decreased plasma insulin levels and insulin resistance in asymptomatic middle-aged adults. Cardiovasc. Diabetol., 11:80, pp. 1-9, 2012.
DeFronzo, R. A. et al., Pathogenesis of Type 2 Diabetes Mellitus, Chapter 6, in Diabetes and Carbohydrate Metabolism, www.endotext.org, 2011
Taguchi, T. et al., Hepatic glycogen breakdown is implicated in the maintenance of plasma mannose concentration, Am. J. Physiol. Endocrinol. Metab. 288(3):E534-E540, 2005.
Kalhan, S. C. et al., Plasma metabolomic profile in nonalcoholic fatty liver disease, Metabolism, 60(3):404-413, 2010.
Gall, W. E. et al., Alpha-hydroxybutyrate is an early biomarker of insulin resistance and glucose intolerance in a non-diabetic population, PLoS, 5(5):e10883, pp. 1-11, 2010.

What is claimed is:

1. In a computer processor, a method of generating a report presenting a patient-specific information relevant to assessing a patient's cardiodiabetes risk, the method comprising:
a. collecting, using the processor, the results of a biomarker test specific to a patient, wherein the biomarker test comprises quantitative measurement of at least one biomarker from at least three of the following panels: (1) a total glycemic control panel; (2) a beta cell function panel; (3) an insulin resistance panel; (4) an inflammation panel; and (5) a dyslipidemia panel;
b. selecting, using the processor, a cardiodiabetes categorical risk level based on the patient's results of the biomarker test;
c. organizing, using the processor, the results of the biomarker test and the cardiodiabetes categorical risk level in a patient-specific cardiodiabetes health report; and
d. presenting the patient-specific cardiodiabetes health report, wherein the report comprises the cardiodiabetes categorical risk level assessing the cardiodiabetic health significance of the results of each biomarker test from each biomarker panel, wherein the cardiodiabetes categorical risk level is assigned based on a comparison of the biomarker test results of the patient with a reference value range.

2. The method of claim 1, wherein said total glycemic control panel comprises:
a. one or more biomarkers selected from the group consisting of glucose, HbA1c, fructosamine, glycation gap, D-mannose, 1,5-anhydroglucitol (1,5-AG) and,
optionally,
b. α-hydroxybutyrate (AHB).

3. The method of claim 1, wherein said beta cell function panel comprises:
a. one or more biomarkers selected from the group consisting of serum amylase, anti-glutamic acid decarboxylase (GAD) autoantibody, c-peptide, and intact pro-insulin and,
optionally,
b. one or more biomarkers selected from the group consisting of glucagon-like peptide 1 (GLP-1); c-peptide/insulin ratio; intact pro-insulin/insulin ratio; [c-peptide+pro-insulin]/insulin ratio; an autoantibody against pancreatic islet cells; an autoantibody against amylase alpha-2; and α-hydroxybutyrate (AHB).

4. The method of claim 1, wherein said insulin resistance panel comprises:
a. one or more biomarkers selected from the group consisting of D-mannose, leptin, adiponectin, ferritin, and free fatty acids (FFA) and,
optionally,
b. one or more biomarkers selected from the group consisting of α-hydroxybutyrate (AHB); oleic acid; linoleoyl-glycerophosphocholine (L-GPC); lipoprotein insulin resistance (LP-IR) score; glucagon-like peptide 1 (GLP-1); mannose binding lectin (MBL) level, activity, genetic polymorphisms or known haplotypes thereof; and body mass index (BMI).

5. The method of claim 1, wherein said inflammation panel comprises:
a. one or more biomarkers selected from the group consisting of lipoprotein-associated phospholipase A₂ (LpPLA₂), fibrinogen, high sensitivity C-reactive protein (hsCRP), myeloperoxidase (MPO) and F2-isoprostanes and,
optionally,
b. one or more biomarkers selected from the group consisting of serum amyloid A and variants thereof; HSP-70; IL-6; TNF-α; haptoglobin and variants thereof; secretory phospholipase A2 (sPLA2); pregnancy-associated plasma protein-A (PAPP-A); and mannose binding lectin (MBL) level, activity, genetic polymorphisms or known haplotypes thereof.

6. The method of claim 1, wherein said dyslipidemia panel comprises:
a. one or more biomarkers selected from the group consisting of LDL-C; HDL-C; triglycerides; apolipoprotein B-48 (ApoB-48); remnant-like lipoprotein particles (RLPs) or RLP-associated cholesterol (RLP-c); linoleoyl-glycerophosphocholine (L-GPC); and at least one additional lipid particle measurement selected from the group consisting of LDL-P, HDL-P (total), large VLDL-P, small LDL-P, large HDL-P, VLDL size, LDL size, HDL size and LP-IR score and,
optionally,
b. one or more biomarkers selected from the group consisting of the lipid particle measurements of enumerated in FIGS. 2 and 3; the measurement of cholesterol and/or triglycerides contained within one or more specific subtypes of lipoprotein particles and remnants thereof; and mannose binding lectin (MBL) level, activity, genetic polymorphisms or known haplotypes thereof.

7. The method of claim 2, wherein said total glycemic control panel comprises two or more biomarkers selected from the group consisting of glucose, HbA1c, fructosamine, glycation gap, D-mannose, 1,5-anhydroglucitol (1,5-AG).

8. The method of claim 2, wherein said total glycemic control panel comprises three or more biomarkers selected from the group consisting of glucose, HbA1c, fructosamine, glycation gap, D-mannose, 1,5-anhydroglucitol (1,5-AG).

9. The method of claim 3, wherein said beta cell function panel comprises two or more biomarkers selected from the group consisting of serum amylase, anti-glutamic acid decarboxylase (GAD) autoantibody, c-peptide, and intact pro-insulin.

10. The method of claim 3, wherein said beta cell function panel comprises three or more biomarkers selected from the group consisting of serum amylase, anti-glutamic acid decarboxylase (GAD) autoantibody, c-peptide, and intact pro-insulin.

11. The method of claim 4, wherein said insulin resistance panel comprises two or more biomarkers selected from the group consisting of D-mannose, leptin, adiponectin, ferritin, and free fatty acids (FFA).

12. The method of claim 4, wherein said insulin resistance panel comprises three or more biomarkers selected from the group consisting of D-mannose, leptin, adiponectin, ferritin, and free fatty acids (FFA).

13. The method of claim 5, wherein said inflammation panel comprises two or more biomarkers selected from the group consisting of lipoprotein-associated phospholipase A₂ (LpPLA₂), fibrinogen, high sensitivity C-reactive protein (hsCRP), myeloperoxidase (MPO) and F2-isoprostanes.

14. The method of claim 5, wherein said inflammation panel comprises three or more biomarkers selected from the group consisting of lipoprotein-associated phospholipase A₂ (LpPLA₂), fibrinogen, high sensitivity C-reactive protein (hsCRP), myeloperoxidase (MPO) and F2-isoprostanes.

15. The method of claim 6, wherein said dyslipidemia panel comprises two or more biomarkers selected from the group consisting of LDL-C; HDL-C; triglycerides; apolipoprotein B-48 (ApoB-48); remnant-like lipoprotein particles (RLPs) or RLP-associated cholesterol (RLP-c); linoleoyl-glycerophosphocholine (L-GPC); and at least one additional lipid particle measurement selected from the group consisting of LDL-P, HDL-P (total), large VLDL-P, small LDL-P, large HDL-P, VLDL size, LDL size, HDL size and LP-IR score.

16. The method of claim 6, wherein said dyslipidemia panel comprises three or more biomarkers selected from the group consisting of LDL-C; HDL-C; triglycerides; apolipoprotein B-48 (ApoB-48); remnant-like lipoprotein particles (RLPs) or RLP-associated cholesterol (RLP-c); linoleoyl-glycerophosphocholine (L-GPC); and at least one additional lipid particle measurement selected from the group consisting of LDL-P, HDL-P (total), large VLDL-P, small LDL-P, large HDL-P, VLDL size, LDL size, HDL size and LP-IR score.

17. The method of claim 1, wherein said cardiodiabetes categorical risk level is selected by comparing the biomarker test results of the patient with the standard reference levels of the biomarkers.

18. The method of claim 17, wherein said cardiodiabetes categorical risk level is categorized as optimal (low risk), intermediate (elevated risk) or high risk.

19. The method of claim 1, wherein said method further comprises
a. evaluating said cardiodiabetes categorical risk level against one or more clinical endpoint components of cardiodiabetic disease, said one or more clinical endpoint components of cardiodiabetic disease includes measurement of blood glucose level at any time point in an OGTT or mixed meal challenge, measurement of blood insulin level at any time during an OGTT or mixed meal challenge, early signs of impaired first and/or second phase insulin secretion, early signs of impaired incretin response, early signs of impaired glucose disposal rate, early signs of adipose insulin resistance, early signs of hepatic insulin resistance, early signs of microvascular cardiodiabetic disease, and early signs of macrovascular cardiovascular disease, and
b. adding said evaluation to said patient-specific cardiodiabetes health report.

20. The method of claim 1, wherein said patient-specific report provides information relative to a patient's risk of a cardiodiabetes disorder and complications thereof.

21. The method of claim 20, wherein said cardiodiabetes disorder and complications thereof are selected from the group consisting of insulin resistance, metabolic syndrome, type 2 diabetes mellitus (T2DM), type 1 diabetes mellitus (T1DM), fatty liver, diabetic nephropathy, diabetic neuropathy, vasculitis, atherosclerosis, coronary artery disease (CAD), vulnerable plaque formation, myocardial infarction (MI), cardiomyopathy, endothelial dysfunction, hypertension, occlusive stroke, ischemic stroke, transient ischemic event (TIA), deep vein thrombosis (DVT), dyslipidemia, gestational diabetes (GDM), periodontal disease, obesity, morbid obesity, chronic and acute infections, pre-term labor, diabetic retinopathy, and systemic or organ-specific inflammation.

22. The method of claim 1, further comprises selecting a recommendation for a therapy regimen for the patient based on said patient-specific cardiodiabetes health report.

23. The method of claim 22, wherein said therapy regimen includes administration of a drug or supplement; additional diagnostic testing; treatment for chronic infection; referral to a health specialist or a related specialist; making or maintaining lifestyle choices based on said patient-specific cardiodiabetes health report, or combinations thereof.

24. The method of claim 23, wherein said drug is an anti-inflammatory agent, an antithrombotic agent, an anti-platelet agent, a fibrinolytic agent, a lipid reducing agent, a direct thrombin inhibitor, a glycoprotein IIb/IIIa receptor inhibitor, an agent that binds to cellular adhesion molecules and inhibits the ability of white blood cells to attach to such molecules, a PCSK9 inhibitor, an MTP inhibitor, mipmercin, a calcium channel blocker, a beta-adrenergic receptor blocker, an angiotensin system inhibitor, a glitazone, a GLP-1 analog, thiazolidinedionones, biguanides, neglitinides, alpha glucosidase inhibitors, an insulin, a dipeptidyl peptidase IV inhibitor, metformin, sulfonurea or peptidyl diabetic drugs.

25. The method of claim 23, wherein the lifestyle choices involve changes in diet and nutrition, changes in exercise, smoking reduction or elimination, or a combination thereof.

26. The method of claim 1, wherein the sample is selected from the group consisting of a blood component, saliva and urine.

27. The method of claim 1, wherein the computer processor is operably coupled to a computer database.

28. The method of claim 1, wherein the computer processor includes executed software programs for data interpretation.

29. The method of claim 1, wherein the report is printed, faxed, or in an electronic format viewable on a personal computer or handheld device.

30. The method of claim 1, wherein the quantitative measurements of the biomarkers are transformed collectively by a mathematical operation using the processor for generating a cardiodiabetes index score and wherein said cardiodiabetes categorical risk level is assigned in conjunction with said generated cardiodiabetes index score by the processor.

31. The method of claim 30, wherein said generated cardiodiabetes index score is compared with a reference value range.

32. The method of claim 30, wherein said generated cardiodiabetes index score is assigned to a cardiodiabetes categorical risk level comprising optimal (low risk), intermediate (elevated risk) or high risk.

33. The method of claim 30, wherein said generated cardiodiabetes index score is additionally evaluated against one or more clinical endpoint components of cardiodiabetic disease, said one or more clinical endpoint components of cardiodiabetic comprise measurement of blood glucose level at any time point in an OGTT or mixed meal challenge, measurement of blood insulin level at any time during an OGTT or mixed meal challenge, early signs of impaired first and/or second phase insulin secretion, early signs of impaired incretin response, early signs of impaired glucose disposal rate, early signs of adipose insulin resistance, early signs of hepatic insulin resistance, early signs of microvascular cardiodiabetic disease, and early signs of macrovascular cardiovascular disease.

34. The method of claim 1, wherein said patient-specific cardiodiabetes health report includes a cardiodiabetes index score and wherein said cardiodiabetes categorical risk level is assigned in conjunction with said generated cardiodiabetes index score by said processor.
